(19) United States
(12) Patent Application Publication
(10) Pub. No.: US 2006/0063894 A1
(43) Pub. Date: Mar. 23, 2006

(54) Degradation resistant polyurethanes

(76) Inventors: Ivan Alferiev, Clementon, NJ (US); Robert J. Levy, Merion Station, PA (US); Stanley J. Stachelek, Philadelphia, PA (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 11/233,149

(22) Filed: Sep. 21, 2005

Related U.S. Application Data
(60) Provisional application No. 60/611,780, filed on Sep. 21, 2004.

(51) Int. Cl. C08G 18/00

(52) U.S. Cl. 525/452

(57) ABSTRACT

A degradation resistant polyurethane and methods of making and using thereof wherein the degradation resistant polyurethane has a modified hard segment which includes a urethane nitrogen and an antioxidant substituent pendant from the urethane nitrogen.

### CROSS-REFERENCE TO RELATED APPLICATIONS

This application claims the benefit of U.S. Provisional Application No. 60/611,780, filed Sep. 21, 2004.

### STATEMENT REGARDING FEDERALLY SPONSORED RESEARCH OR DEVELOPMENT

This research was supported in part by U.S. Government funds (National Heart, Lung and Blood Institute grant number NHLBI59730), and the U.S. Government may therefore have certain rights in the invention.

### BACKGROUND OF THE INVENTION

1. Field of Invention

This invention relates generally to the field of derivatized polyurethane polymers for in vitro and in vivo use. More specifically, this invention relates to derivatized polyurethane polymers resistant to degradation.

2. Description of Related Art

Polyurethanes (PUs), i.e., polymers which comprise repeating units having a urethane group in the polymer backbone, can be used to form bulk polymers, coatings, fillings, and films. Notably, polyurethanes are also readily machinable once set. Polyurethanes display various degree of flexibility depending on selection of monomers and a degree of cross-linking. Polyurethanes are well-known for their bio- and blood-compatibility. These properties of polyurethanes have rendered them useful for medical and non-medical purposes.

Polyurethanes are widely used in implants, particularly cardiovascular implants, as highly biocompatible biomaterials. For example, polyurethanes have been employed in the manufacture of pacemaker electrodes, vascular grafts, and artificial heart valves.

Medical uses of polyurethanes have been limited by oxidative degradation of polyurethane products. Degradation is usually manifest by structural deterioration of polyurethane medical implants, which can be observed to be either gross failure or surface micro-cracks. The oxidation of surface ethers of poly(ether urethanes) has been hypothesized to be the primary cause of surface cracking^{1,2}, and thus many polyurethane vascular implants have been composed of the potentially more oxidation resistant poly(carbonate urethanes)³. However, recent evidence shows that a mechanism of oxidative degradation, comparable to that affecting poly(ether-urethanes), is also operative in poly(carbonate urethanes)^{2,4}.

Polyether and polyester-based PUs are oxidation sensitive, and polyester-based PUs are also hydrolytically unstable. Various chemical modifications of soft segments containing polyether have been performed to improve stability of resulting PUs. Also, there have been numerous attempts to create oxidative-resistant polyurethane formulations by mixing antioxidants with polymeric compositions (see Zdrahala et al., Biomedical applications of polyurethanes: a review of past promises, present realities, and a vibrant future, J. Biomater. Appl. 1999, 14, 67-90; Anderson et al., Recent advances in Biomedical Polyurethane Biostability and Biodegradation, Polymer International, 46 (1998), 163-171). However, there is a problem with such addition because antioxidants not bound to the polyurethane backbone tend to leach out of the implanted polymer into the bloodstream. As described by Anderson et al., the most acceptable for biomedical purposes is the use of a natural antioxidant Vitamin E (in alfa-tocopherol form) as an antioxidant additive to polyurethanes as compared to synthetic antioxidants (e.g., SANTOWHITE and IRANOX). However, the protective effect can be only temporary because no covalent bond was engineered for attaching vitamin E to polyurethanes.

Aromatic amines have been used as antioxidant additives in lubricant compositions as disclosed in U.S. Pat. No. 5,213,699 to Babiarz et al., and U.S. Pat. No. 5,198,134 to Steinberg et al.

Despite above described efforts, there is a need for polyurethanes capable of preventing and/or withstanding oxidation and degradation caused by oxidation. The use of chemically bound anti-oxidants for preventing oxidative degradation of poly(ether urethanes) implants is an important alternative to using other elastomers such as, for example, poly(carbonate urethanes)⁵.

Additionally, a need exists for methods of making such polyurethanes. As those skilled in the art will appreciate, a need exists for implantable devices comprising degradation resistant polyurethane capable of preventing and/or withstanding degradation caused by oxidation.

All references cited herein are incorporated herein by reference in their entireties.

### BRIEF SUMMARY OF THE INVENTION

The invention provides degradation resistant polyurethanes and methods for covalently modifying polyurethanes with chemical moieties that confer resistance to oxidative destruction. This modification can be performed post-or pre-polymerization on polyurethanes. The oxidation resistant polyurethanes of the invention are useful for medical implants and other commercial devices and coatings for applications in which resistance to oxidation is desired.

The degradation resistant polyurethane of the invention comprises a modified hard segment having a urethane nitrogen and an antioxidant substituent, wherein the antioxidant substituent is pendant from the urethane nitrogen. In certain embodiments, the antioxidant substituent is a member selected from the group consisting of a phenol derived substituent, a phenylendiamine derived substituent, a naphtalenediamine derived substituent, and a vitamine E derived substituent. In certain embodiments, the phenol derived substituent comprises a 2,6-di-tert-butylphenol derived substituent.

In certain embodiments, the antioxidant substituent is pendant from about 0.5 to 55% of urethane nitrogen atoms. In certain embodiments, the lipid substituent is pendant from 1 to 25% of urethane nitrogen atoms.

Degradation resistant polyurethane of the invention can be provided in a shape of an article or in a shape of a coating on the article.

Implantable devices comprising the degradation resistant polyurethane of the invention capable of preventing and/or withstanding degradation caused by oxidation are also provided.

Further provided is a method of making the degradation resistant polyurethane, the method includes (a) providing a polyurethane comprising a hard segment comprising a urethane amino moiety, (b) treating the polyurethane to form a derivatized polyurethane that comprises a derivatized hard segment having a first reactive group pending from a urethane nitrogen, and wherein the derivatized hard segment is depicted by a formula:
-A-N(Y-(FG)ₙ)(C(═O)O—)
wherein n is an integer from 1 to 3, FG is the first reactive group which can be a halogen, a carboxyl group, a substituted carboxyl group, a sulfonate ester and an epoxy group, and Y is an (n+1)-valent organic radical comprising at least one carbon atom, (c) providing a derivatized antioxidant comprising a second reactive group, and (d) reacting the first reactive group with the second reactive group.

In certain embodiments of the method, Y is a bivalent organic radical selected from the group consisting of C₁ to C₂₀ alkylene, C₁ to C₂₀ alkyleneamino, C₁ to C₂₀ alkyleneoxy, C₁ to C₂₀ haloalkylene, C₂ to C₂₀ alkenylene, C₆ to C₂₀ arylene, a modified C₂ to C₂₀ alkenylene having at least one carbon substituted by a halogen group, C₂ to C₂₀ alkenylene having one or more O, S, or N atoms incorporated into an alkenylene chain, a bivalent heterocyclic radical, and mixtures thereof.

In certain embodiments of the method, Y is a member selected from the group consisting of a C₁-C₆ alkylene and (CH₂)_{q}S(CH₂)ₘ, wherein q is 1-6, and m is 1-2.

In certain embodiments of the method, treating the polyurethane means reacting the polyurethane with a multifunctional linker reagent of a formula:
LG-Y-(FG)ₙ
wherein LG is a leaving group selected from the group consisting of a halogen, a carboxyl group, a sulfonate ester, and an epoxy group. In one variant of this embodiment, the multifunctional linker reagent is a member selected from the group consisting of a dibromoalkyl compound, a bromo-carboxyalkyl compound, and a bromo-epoxyalkyl compound.

In certain embodiments of the method, the hard segment comprises an aromatic or a cycloaliphatic group bound to the urethane nitrogen.

In certain embodiments of the method, the second reactive group is at least one of an amino group and a thiol group.

In certain embodiments of the method, the derivatized hard segment comprises the aromatic group bound to the urethane nitrogen, the first reactive group is the carboxyl group, the second reactive group is the amino group and the derivatized polyurethane is reacted with N-hydroxysuccinimide.

In certain embodiments of the method, providing an additional reactant comprising a functional moiety is also contemplated. The order of addition of the derivatized antioxidant and the additional reactant is not crucial. In one variant of this embodiment, the additional reactant is provided simultaneously with the derivatized antioxidant. Non-limiting examples of the additional reactant are steroid lipid and bisphosphonate.

Also provided is a method of preventing or inhibiting oxidative degradation of an article, the method comprising providing the degradation resistant polyurethane, said degradation resistant polyurethane is in a shape of the article or in a shape of a coating on the article; and contacting the article or the coating with oxygen or oxygen-free radicals and thereby preventing or inhibiting oxidative degradation of the article. In one variant, the article is contacted with a tissue. A non-limiting example of the article is an implantable device.

### BRIEF DESCRIPTION OF SEVERAL VIEWS OF THE DRAWINGS

The invention will be described in conjunction with the following drawings in which like reference numerals designate like elements and wherein:

FIG. 1A is a scheme depicting a non-limiting example of derivatized antioxidants of the present invention. FIG. 1A shows thiol-derivatized 2,6-di-tert-butylphenol, wherein p is 1 or 0, FG is a thiol group or an amino group, and X is a C₁-C₁₈ alkylene or a C₁-C₁₈ arylene, optionally comprising heteroatoms (O, N, S, etc.). When p equals 0, the functional group is directly bound to the benzene ring.

FIGS. 1B-1D are non-limiting examples of antioxidants that can be used in the invention after derivatization or modification conferring a reactive group capable of covalently reacting with derivatized polyurethane. FIG. 1B shows Vitamin E. FIG. 1C shows N-substituted p-phenylenediamines (as described in U.S. Pat. No. 5,213,699), wherein R^{1,2,3,4} can be alkyl, allyl, benzyl, phenyl (Ph) or hydrogen FIG. 1D shows N-substituted 1,8- or 1,5-naphthalenediamines (as described in U.S. Pat. No. 5,198,134), wherein R^{1,2} can be allyl, alkylthiomethyl or hydrogen. FIGS. 1B, 1C and 1D are prior art.

FIGS. 2A and 2B are schemes depicting preparation of the degradation resistant polyurethane of the invention modified with thiol-derivatized 2,6-di-tert-butylphenol (DBP) covalently bound to a urethane nitrogen, wherein polyurethane was first derivatized to contain a bromoalkyl group. In FIG. 2A, the urethane nitrogen is bound to a group shown herein as “A,” which is an aromatic or a cycloaliphatic group such as, for example, a derivative of benzene or cyclohexane. In FIG. 2B, “A” is a derivative of benzene.

FIG. 3 is a scheme depicting preparation of the degradation resistant polyurethane of the invention modified with thiol-derivatized 2,6-di-tert-butylphenol covalently bound to a urethane nitrogen, wherein polyurethane was first derivatized to contain an epoxy group.

FIG. 4 is a scheme depicting preparation of the degradation resistant polyurethane of the invention modified with amino-derivatized 2,6-di-tert-butylphenol covalently bound to a urethane nitrogen, wherein polyurethane was first derivatized to contain a carboxy group. Carboxylated polyurethane was treated with N-hydroxysuccinimide (NHS) and dicyclohexylcarbodiimide (DCC) in the presence of N,N-dimethylacetamide (DMAc) at about 20° C.; “A” is an aromatic or a cycloaliphatic group such as, for example, a derivative of benzene or cyclohexane and Y is an (n+1)-valent organic radical comprising at least one carbon atom; in this embodiment Y is preferably (CH₂)₅; (CH₂)₁₀; (CH₂)₆SCH₂; (CH₂)₆SCH₂CH₂. Amino substituted 2,6-di-tert-butylphenol was then added, wherein X is an aliphatic spacer as described above.

FIG. 5A is a scheme depicting preparation of thiolated p-phenylenediamine antioxidant.

FIG. 5B is a scheme depicting preparation of degradation resistant polyurethane of the invention modified with thiolated p-phenylenediamine antioxidant.

FIG. 6 is a scheme depicting preparation of thiolated 2,6-di-tert-butylphenolic antioxidant. The thiolated antioxidant can be prepared by alkylation of 2,6-di-tert-butylhydroquinone (easily available from the commercial 2,6-di-tert-butyl-1,4-benzoquinone) with an excess of 1,4-dibromobutane in DMSO in the presence of a base (e.g., tetramethylammonium hydroxide). The resulting bromide can be converted into the desired thiol via, for example, thiuronium salt.

FIG. 7 is a scheme depicting preparation of the degradation resistant polyurethane of the invention modified with cholesterol and antioxidant; PU denotes a part of the polyurethane macromolecule.

FIG. 8 is a block diagram showing normalized data from FTIR spectra demonstrating changes of the 1173 peak which occur during oxidation. This figure demonstrates that these changes are reduced by modifications of polyurethane; tested examples include unmodified polyurethane TECOTHANE (block I), cholesterol-modified polyurethane (block II), DBP modified polyurethane (block III), and cholesterol-DBP modified polyurethane (block IV).

FIGS. 9A and 9B show FTIP spectra demonstrating changes of the 1173 peak in H₂O and H₂O₂ for unmodified polyurethane TECOTHANE (IA and IB), cholesterol-modified polyurethane (IIA and IIB), DBP modified polyurethane (IIIA and IIIB), and cholesterol-DBP modified polyurethane (IVA and IVB).

FIG. 10 is a photograph of samples of polyurethane modified with antioxidant and cholesterol (shown as B) and unmodified polyurethane (shown as A) films stored in air at ambient temperatures for nine months.

FIG. 11 is a scheme depicting a synthesis of 4-mercapto-2,6-di-tert-butylphenol. (FIG. 1 in the article) FIG. 12A is a schematic diagram of covalently appending di-tert-butylphenol moieties to bromoalkylated urethane hard segments of poly(ether urethane) (TECOTHANE TT-1074A).

FIG. 12A is a schematic diagram of covalently appending di-tert-butylphenol moieties to bromoalkylated urethane hard segments of poly(ether urethane) (TECOTHANE TT-1074A) (a variant of FIG. 2A).

FIG. 12B shows ¹H NMR spectra (in DMF-d₇) of bromobutylated TECOTHANE TT-1074A (top) and DBP-modified TECOTHANE (bottom).

FIG. 13A demonstrates FTIR spectra of TECOTHANE TT-1074A (PU) incubated in (a) distilled water or (b) an oxidation solution CoCl₂/20% H₂O₂ for 15 days at 37° C.; (c) PU modified with cholesterol (PU+Chol); (d) DBP (PU+DBP); and (e) a combinatorial modification of cholesterol, DBP and PU (PU+Chol+DBP).

FIG. 13B is a bar graph demonstrating graphical representation of soft segment ether (for all polyether-urethanes, PU), changes per FTIR at 1110 cm⁻¹, or soft-segment FTIR changes for polycarbonate at urethanes (BIONATE, CARBOSIL) 1253 cm⁻¹, in oxidized samples for 15 days at 37° C. Polyurethane modified with cholesterol (PU+Chol), polyurethane modified with DBP (PU+DBP), and polyurethane modified with DBP and cholesterol (PU+Chol+DBP) showed significantly more soft-segment ether retention than unmodified PU films. BIONATE 80A retained significantly more of the soft segment than the other polycarbonate, CARBOSIL 90A, tested (re. 1253 cm⁻¹ changes). Percent ether=(A₁₁₁₀/A₁₅₉₀)_{treated}/(A₁₁₁₀/A₁₅₉₀)_{untreated}×100%. Percent carbonate=(A₁₂₅₃/A₁₅₉₀)_{treated}/(A₁₂₅₃/A₁₅₉₀)_{untreated}×100%. * p<0.05.

FIG. 14 is a graphical representation of ether cross-linking in covalently modified polyether urethanes and polycarbonate urethanes as assessed by normalized 1170 cm⁻¹ peak heights obtained via FTIR spectral analyses.

FIG. 15 contains scanning electron micrographs of polyurethane configurations showing changes in surface morphology as a result of oxidative degradation for TECOTHANE (PU), PU+Chol, PU+DBP, PU+Chol+DBP, and CARBOSIL.

### DETAILED DESCRIPTION OF THE INVENTION

The present invention is based upon the discovery of polyurethanes, which have antioxidants substituents pendant from urethane nitrogens and methods of making such polyurethanes. The invention was driven by the desire to provide permanent protection from the oxidative degradation, which is achieved herein by covalent attachment of antioxidants to the polyurethane backbone. In polyurethanes of the present invention, the antioxidant cannot leach out of the polymer without a complete degradation of the polymeric backbone. The degradation resistant polyurethane of the invention comprises a modified hard segment having a urethane nitrogen and an antioxidant substituent, wherein the antioxidant substituent is pendant from the urethane nitrogen.

In certain embodiments, the antioxidant substituent is selected from a phenol derived substituent, a phenylendiamine derived substituent, a naphtalenediamine derived substituent, and a vitamine E derived substituent. In certain embodiments, the phenol derived substituent comprises a 2,6-di-tert-butylphenol derived substituent.

In certain embodiments, the 2,6-di-tert-butylphenol derived substituent has a formula: 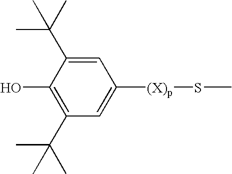
wherein p equals 1 or 0, and X is a C₁-C₂₀ alkylene or a C₁-C₂₀ arylene, wherein the C₁-C₂₀ alkylene and/or the C₁-C₂₀ arylene optionally comprise heteroatoms.

In certain embodiments, the 2,6-di-tert-butylphenol derived substituent is a 4-hydroxy-3,5-di-tert-butyltoluene derived substituent.

In certain embodiments, the hard segment comprises an aromatic or a cyclohexane group bound to the urethane nitrogen. In certain embodiments, the modified hard segment has the formula: 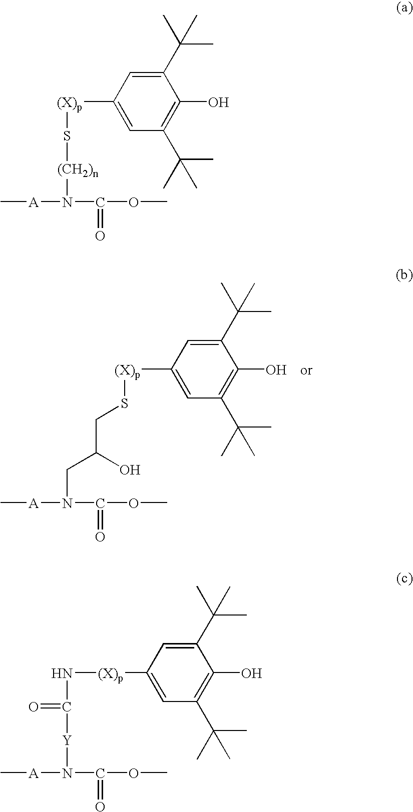
wherein A is an aromatic or a cycloaliphatic group, Y is an (n+1)-valent organic radical comprising at least one carbon atom.

In certain embodiments, the modified hard segment has the formula:

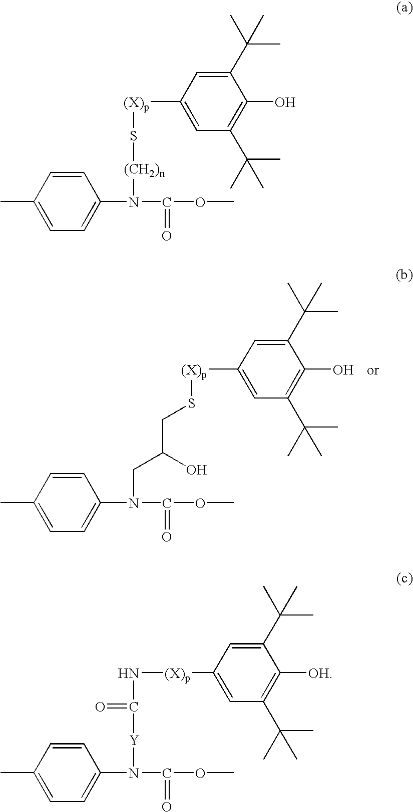

The degree of modification of available urethane nitrogen atoms depends on degradation protection required and percentage of soft segments which are prone to degradation. A person skilled in the art will be able to select required degree of modification based on the guidance provided in this disclosure and knowledge available in the art without undue experimentation.

In certain embodiments, the antioxidant substituent is pendant from about 0.5 to 55% of urethane nitrogen atoms. In certain embodiments, the lipid substituent is pendant from 1 to 25% of urethane nitrogen atoms.

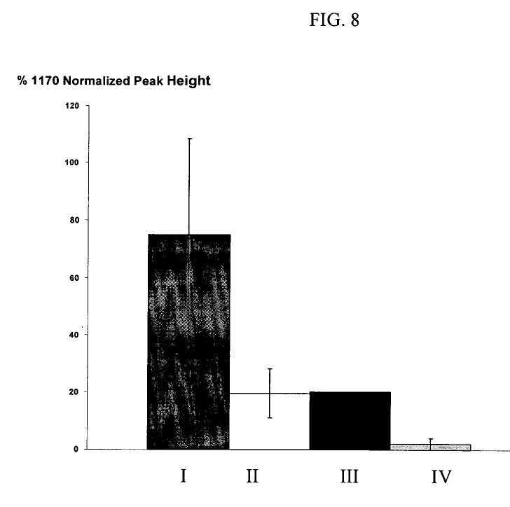

Degradation resistant polyurethanes of the invention can have different antioxidant substituent pendant from the urethane nitrogens. Further, additional functional moieties (i.e., moieties other than antioxidant substituent which can confer properties other than degradation resistance, e.g., calcification resistance) can also be pendant from different urethane nitrogens. In certain embodiments, the functional moiety is at least one of steroid lipid and bisphosphonate. A synergistic effect was observed when the 2,6-di-tert-butylphenol derived substituent was used as the antioxidant substituent and cholesterol was used as the functional moiety. In FIG. 8, FTIP spectra of changes of the 1173 peak which occur during oxidation demonstrate these changes are reduced by modifications of polyurethane as compared to the unmodified polyurethane TECOTHANE (block I), cholesterol-modified polyurethane (block II), DBP modified polyurethane (block III), and cholesterol-DBP modified polyurethane (block IV). It was unexpected that the peak was drastically reduced when both cholesterol and DBP substituents were used to modify polyurethane.

The degradation resistant polyurethane of the invention can be provided in a shape of an article or in a shape of a coating on the article. As those skilled in the art would appreciate, manufacturing articles or coatings using the degradation resistant polyurethane of the invention can be achieved by methods known in the art for polyurethanes such as, for example, extrusion, molding, and spraying (see, for example, U.S. Pat. No. 4,496,535 to Gould et al., and U.S. Pat. No. 5,071,683).

Implantable devices comprising the degradation resistant polyurethane of the invention capable of preventing and/or withstanding degradation caused by oxidation are also provided.

Definitions

As used herein, each of the following terms has the meaning associated with it in this section, absent an express indication to the contrary.

The articles “a” and “an” are used herein to refer to one or to more than one (i.e. to at least one) of the grammatical object of the article. By way of example, “an element” means one element or more than one element.

“Implantation” and grammatical forms thereof, refers to the process of contacting a device with a tissue of an animal in vivo wherein the contact is intended to continue for a period of hours, days, weeks, months, or years without substantial degradation of the device. Such contact includes, for example, grafting or adhering the device to or within a tissue of the animal and depositing the device within an orifice, cavity, incision, or other natural or artificially-created void in the body of the animal.

An “implantable” device is the device, which is adapted for permanent or temporary insertion into or application against a tissue of an animal such as, for example, a human. Examples of implantable devices or components include, but are not limited to, an artificial heart, cardiac pacer leads, automatic implantable cardiodefibrilator leads, a prosthetic heart valve, a cardiopulmonary bypass membrane, a ventricular assist device, an annuloplasty ring, a dermal graft, a vascular graft, a vascular, cardiovascular, or structural stent, a catheter, a guide wire, a vascular or cardiovascular shunt, a dura mater graft, a cartilage graft, a cartilage implant, a pericardium graft, a ligament prosthesis, a tendon prosthesis, a urinary bladder prosthesis, a pledget, a suture, a permanently in-dwelling percutaneous device, an artificial joint, an artificial limb, a bionic construct (i.e. one of the aforementioned devices or components comprising a microprocessor or other electronic component), and a surgical patch.

An “oxirane” ring or group is also known as an epoxy ring or group.

A “thiol-reactive functional group” is a moiety capable of reacting with thiol group (—SH) such that a covalent bond is formed between an atom of the compound containing the thiol-reactive functional group and the sulfur atom of the thiol group.

A “thiolating agent” is any agent, such as a thiol nucleophile, which introduces a thiol group or a sulfide which is readily transformed to a thiol by, for example, hyrdolysis or reduction. Examples of thiolating reagents include, without limitation, thiosulfate, thiourea, trityl- and tert-butylmercaptans, thiocyanate, and thioalkanoic acids such as thioacetic acid. Reagents such as thiosulfate, thiourea, trityl- and tert-butylmercaptans, and thiocyanate require further treatment by, for example, hydrolysis or reduction of the resultant sulfur-containing compound to obtain the desired thiol group. In a preferred embodiment, the thiolating agent is thioacetic acid.

The term “alkyl” refers to a hydrocarbon containing from 1 to 20 carbon atoms unless otherwise defined. An alkyl is an optionally substituted straight, branched or cyclic saturated hydrocarbon group. When substituted, alkyl groups may be substituted at any available point of attachment. When the alkyl group is said to be substituted with an alkyl group, this is used interchangeably with “branched alkyl group”. Exemplary unsubstituted groups include methyl, ethyl, propyl, isopropyl, n-butyl, t-butyl, isobutyl, pentyl, hexyl, isohexyl, heptyl, 4,4-dimethylpentyl, octyl, 2,2,4-trimethylpentyl, nonyl, decyl, undecyl, dodecyl, and the like. Exemplary substituents may include but are not limited to one or more of the following groups: halo (such as F, Cl, Br, I), haloalkyl (such as CCl₃, or CF₃), alkoxy, alkylthio, hydroxy, carboxy (—COOH), carbonyl (—C(═O)), epoxy, alkyloxycarbonyl (—C(═O)—OR), alkylcarbonyloxy (—OC(═O)—R), amino (—NH₂), carbamoyl (NH₂C(═O)— or NHRC(═O)—), urea (—NHCONH₂), alkylurea (—NHCONHR) or thiol (—SH), wherein R in the aforementioned substituents represents an alkyl radical. Alkyl groups (moieties) as defined herein may also comprise one or more carbon to carbon double bonds or one or more carbon to carbon triple bonds. Alkyl groups may also be interrupted with at least one oxygen, nitrogen, or sulfur atom.

The term “antioxidant” as used herein denotes a natural or synthetic chemical substance that prevents the oxidation of other chemicals such as, for example, polyurethane. Without being bound by a particular theory, the antioxidants protect polyurethanes by “mopping up” active oxygen species, such as superoxide, OH, OOH, etc., and free radicals formed in the processes of oxidation (plus a minor contribution from ionizing radiation) before free radicals damage polyurethanes and other essential molecules. Non-limiting examples of antioxidants useful in this invention are phenols, phenylendiamines, naphtalenediamines, and vitamine E.

The term “modified antioxidant” as used herein denotes the antioxidant which has been modified to contain a reactive group.

The term “antioxidant substituent” as used herein denotes the portion of the modified antioxidant that is pending from the urethane nitrogen upon reacting with the reactive group.

The term “polyurethane,” as used herein, is a polymer that comprises repeating units having a urethane group in the polymer backbone comprising chemically accessible urethane nitrogen. Such polymers include, for example, polyurethane homopolymers, block co-polymers comprising at least one polyurethane block, and polymer blends comprising such homopolymers and block co-polymers. Polyurethanes useful in this invention contain soft segments comprising polymeric diol derivatives such as, for example, polyether, polybutadiene, polydimethylsiloxane, polycarbonate or aliphatic hydrocarbon, and hard segments comprising urethane groups.

Illustrative polyurethanes include but are not limited to F2000 PEU, which is a medical grade polyether-urethane prepared from 4,4-methylenebis(phenylisocyanate), polytetramethyleneoxide (MW ca. 1,000 g/mol), and 1,4-butanediol as a chain extender (Sulzer Carbomedics, Inc., Austin, Tex.); BIOSPAN, which is a medical grade polyurethane-urea, BIONATE™ 80A, which is a medical grade polycarbonate-urethane and CARBOSIL, a thermoplastic silicone-polyether urethane (from Polymer Technology Group Medical, LLC; Berkeley, Calif.); and TECOTHANE™ TT-1074A, which is a medical grade polyether-urethane (Thermedics, Inc., Woburn, Mass.). Such polymers include, for example, both polyether polyurethanes and polyester polyurethanes which may be in the form of homopolymers, block co-polymers comprising at least one polyurethane block, and polymer blends comprising such homopolymers and block co-polymers. The exemplary hard to soft segment ratio of the commercially available polyurethanes are as follows: BIOSPAN (20.5:79.5), CARBOSIL 90A (45:55), and BIONATE 80A (35:65).

Alternatively, polyurethanes can be made by condensing a diisocyanate with a diol, with two or more diols having different structures, or with both a diol and a diamine. It is understood that the proportion of end groups corresponding to the diisocyanate and the diol can be controlled by using an excess of the desired end group. For example, if a reaction is performed in the presence of an excess of the diisocyanate, then the resulting polyurethane will have isocyanate (—NCO) groups at each end.

Preferably, diisocyanate comprises an aromatic or a cycloaliphatic group such as, for example benzene and cyclohexane derivatives.

Depending on the identity of the reaction products used to from them, polyurethanes can behave as elastomers or as rigid, hard thermosets. If the diisocyanate in the synthesis reaction is, for example, 4,4′-methylenebis(phenylisocyanate), then the resultant polyurethane will be relatively inflexible. If the diol in the synthesis reaction is, for example, polytetramethyleneoxide (i.e., HO—(CH₂CH₂CH₂CH₂O)ₖ—H, wherein, e.g., k is about 10 to 30), then the resultant polyurethane will be relatively flexible. Methods of selecting polyurethane precursors which will yield a polyurethane having hard and soft segments which confer a desired property (e.g., flexibility, elastomericity, etc.) to the polyurethane are well known in the art.

Methods of making segmented polyurethanes are also known in the art. In these methods, one or more types of polyurethane precursors (OCN-A-NCO) are reacted with a chain extending compound to yield a segmented polyurethane. By varying the proportions of different types of polyurethane precursors, their end groups, the identity of the chain extender, and the like, the composition of polyurethane segments in the segmented polymer can be controlled, as is known in the art. Medical grade segmented polyurethanes are usually prepared by condensing a diisocyanate with a polymeric diol having a molecular weight of about 1,000 to 3,000 (e.g., polytetramethyleneoxide for polyether-urethanes or polycarbonatediols for polycarbonate-urethanes) in order to form a polyurethane precursor which is subsequently reacted with an approximately equivalent amount of a chain extender (e.g., a diol such as 1,4-butanediol or a diamine such as a mixture of diaminocyclohexane isomers).

The term “derivatized polyurethane,” as used herein, is a polymer that was treated to contain reactive groups pending from urethane nitrogens of hard segments. Hard segments of polyurethanes treated to contain reactive groups are referred to in this disclosure as “derivatized hard segments”. Derivatized hard segments that reacted with derivatized antioxidants are referred to in this disclosure as “modified hard segments”.

A chemical substituent is “pendant” from a backbone of a polymer if it is bound to an atom of a monomeric unit of the polymer. In this context, the substituent is pending from a urethane nitrogen of the backbone of the polyurethane either directly or indirectly, e.g. through a linker moiety.

A “urethane group” is a chemical structure which is part of the backbone of a polymer and which has the following structure:

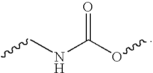

The “backbone” of a polymer is the collection of atoms and chemical bonds there between which link the repeating units of the polymer to one another.

A “urethane nitrogen” is a nitrogen of the urethane group.

Methods of Making Degradation Resistant Polyurethanes

The methods of making the degradation resistant polyurethane of the invention are implemented under mild conditions, such as low temperatures from about −10 to about 20° C., preferably from −10 to 0° C.

Polyurethanes useful in this invention should be derivatized to have functional groups capable of reacting with reactive groups of antioxidants to form antioxidant substituents pendant from the urethane nitrogen.

The derivatized polyurethane comprising functional groups and methods of making thereof are described in detail in U.S. Pat. No. 6,900,282 by inventors, issued on May 31, 2005 and U.S. Pat. No. 6,890,998 by inventors, issued on May 10, 2005, which are incorporated herein in their entireties.

Accordingly, the method of making the degradation resistant polyurethane includes (a) providing a polyurethane comprising a hard segment comprising a urethane amino moiety, (b) treating the polyurethane to form a derivatized polyurethane that comprises a derivatized hard segment having a first reactive group pending from a urethane nitrogen, and wherein the derivatized hard segment is depicted by a formula:
-A-N(Y-(FG)ₙ)(C(═O)O—)
wherein n is an integer from 1 to 3, FG is the first reactive group which can be a halogen, a carboxyl group, a substituted carboxyl group, a sulfonate ester and an epoxy group, and Y is an (n+1)-valent organic radical comprising at least one carbon atom, (c) providing a derivatized antioxidant comprising a second reactive group, and (d) reacting the first reactive group with the second reactive group.

In one embodiment, the process comprises first reacting the urethane amino moiety of a polyurethane with a multifunctional linker reagent of the general formula:
LG-Y-(FG)ₙ
wherein Y (or R_{L}) is a multivalent organic radical. The chemical identity of R_{L} is not critical, except that it must comprise at least one carbon atom. Since “n” can vary between 1 and 3, Y may carry 1, 2, or 3 moieties, respectively, thus providing polyurethanes with mixed substituents. Preferably, “n” is 1, where Y serves as a bivalent organic radical.

Bivalent organic radicals suitable as Y include, for example, straight or branched C₁ to C₂₀ alkylene groups. Illustrative alkylene groups are methylene, ethylene, propylene, butylene, pentylene, and hexylene. Preferably, Y is butylene. The alkylene groups may be substituted by one or more halo substituents, which include —F, —Cl, —Br, and —I.

Other bivalent organic radicals include C₁ to C₂₀ alkyleneamino and C₁ to C₂₀ alkyleneoxy groups. Alkyleneamino groups are alkylene groups that are interrupted by one or more amino fragments. Similarly, C₁ to C₂₀ alkyleneoxy groups are alkylene groups that are interrupted by one or more oxy (i.e., —O—) moieties.

Still other bivalent organic radicals are cyclic moieties such as arylene groups and bivalent heterocyclic radicals. An arylene group is a C₆ to C₁₂ bivalent aromatic hydrocarbon. Exemplary arylene groups are phenylene and napthylenylene. Bivalent heterocyclic radicals are preferably 5- to 6-member heterocycles containing at least one heteroatom selected from N, S, and O, such that two valences on the heterocycle are available for forming bonds. Exemplary heterocycles include thiazoline, thiazolidone, imidazole, imidazoline, thiazole, triazoles, tetrazole, thiadiazole, imidazole, pyridine, and morpholine.

LG is a leaving group selected from the group consisting of a halogen, a carboxyl group, a sulfonate ester, and an epoxy group. Thus, the linker can be a bi-, tri-, tetra-functional linker. Preferred sulfonate esters include but are not limited to mesylate (i.e., CH₃SO₂O—), triflate (i.e., CF₃SO₂O—), and tosylate (i.e., CH₃C₆HSO₂O—). Halo and sulfonate ester groups are exemplary leaving groups. Preferred halogen group is a bromo group. Preferred sulfonate esters include but are not limited to mesylate (i.e., CH₃SO₂O—), triflate (i.e., CF₃SO₂O—), and tosylate (i.e., CH₃C₆H₄SO₂O—).

Each FG is a functional group that is independently selected from halo substituents such as chloro, bromo, and iodo; a carboxyl group; a substituted a carboxyl group, a sulfonate ester; and an epoxy group. The functional group is therefore a leaving group or is a group with which a reactive group of the antioxidant described below forms a bond. When FG is a halo or sulfonate ester group, any carbon atom to which it can be attached is preferably an aliphatic carbon. When FG is an epoxy ring, however, any carbon to which it is attached can be aliphatic, unsaturated, or aromatic.

The multifunctional linker reagent can have various combinations of LG and FG groups and is not limited to the examples above. LG and one, two or three FG groups can be different or the same chemical group.

In one embodiment of the method of the invention, the multi-functional linker reagent is a dibromoalkyl compound, a bromo-carboxyalkyl compound, or a bromo-epoxyalkyl compound. Particularly preferred dibromoalkyl compounds include 1,ω-dibromoalkyl compounds such as 1,6-dibromohexane, 1,4-dibromobutane, and substituted 1,ω)-dibromoalkyl compounds. Particularly preferred bromo-carboxyalkyl compounds include ω-bromocarboxylic acids such as ω-bromohexanoic acid, ω-bromoundecanoic acid, and substituted ω-bromocarboxylic acids. Particularly preferred bromo-epoxyalkyl compounds include bromo-oxiranealkyl compounds such as epibromohydrin.

The reaction described above is preferably performed in an aprotic solvent. The aprotic solvent can be substantially any aprotic solvent. An illustrative aprotic solvent is N,N-dimethylacetamide (DMAc), but a wide variety of other aprotic solvents can be used instead, including, for example, N,N-dimethyl formamide, 1-methyl-2-pyrrolidinone, tetrahydrofuran, dioxane, and dimethyl sulfoxide (DMSO).

Additionally, the reaction is best performed in the presence of a strong base, which renders the polyurethane amino nitrogen atoms into their more nucleophilic anionic forms. The strong base can be substantially any strong base that is soluble in the aprotic solvent used. Exemplary strong bases include sodium hydride, lithium diisopropylamide, sodium or potassium tert-butoxide, dimsyl sodium, lithium hydride, sodium amide, lithium N,N-dicyclohexylamide, and other lithium N,N-dialkylamides.

It is important to consider the effect that a counter-ion of the base may have upon the multi-functional linker, the derivatized polyurethane, or both. For example, the multi-functional linker should not be precipitated from solution, since this would complicate reaction of the linker with the polyurethane. Similarly, if it is desired that the derivatized polymer should remain in solution, a base should be chosen which does not have a counter-ion which would precipitate the derivatized polymer. For example, if the multi-functional linker comprises one or more carboxyl groups and several methylene groups, strong bases which have sodium counter-ions should be avoided. The same bases having lithium counter-ions, however, are preferable.

As noted above, when a multi-functional linker having a relatively high reactivity with polyurethane anionic moieties is used, the strength of the base can be lower than when a multi-functional linker having a lower reactivity is used. Thus, for example, strong bases such as lithium diisopropylamide (LDA) can be used when the linker is, for example, 1,6-dibromohexane, whereas relatively weaker bases such as lithium tert-butoxide are preferred when the linker is more reactive (e.g., 1,4-dibromobutane). Alternatively, lithium tert-butoxide can be used in combination with all multifunctional linker reagents. In this scenario, for example, the yield of bromoalkylation (i.e., the molar ratio of bromoalkylated urethane segments to base) exceeds 90% when lithium tert-butoxide is employed as compared to yields of 50-60% for LDA.

In addition, the functional group(s) of the derivatized polyurethane can be further reacted with another reactant to change one type of functional group to another, e.g., to change a halo group to a carboxyl group, which is further reacted to form a substituted carboxyl group as shown in FIG. 4. In this variant, Y would also comprise a part of the reacted functional group (e.g., —(C═O)— a part of a carboxyl group).

Continuing, the process further comprises reacting the derivatized polyurethane (substituted with at least one —Y(FG)ₙ substituent) with a reactive group of a derivatized antioxidant to yield the degradation resistant polyurethane of the invention. In certain embodiments, the derivatized antioxidant is 4-mercapto-2,6-di-tert-butylphenol and the reactive group is a thiol group.

Antioxidants useful in this invention are modified to contain reactive groups capable of reacting with functional groups of derivatized polyurethanes prepared as described below. A person skilled in the art will be able to select reactive groups for derivatizing polyurethanes and antioxidants based on general knowledge available in the art without undue experimentation, e.g., a thiol group and a thiol reactive group.

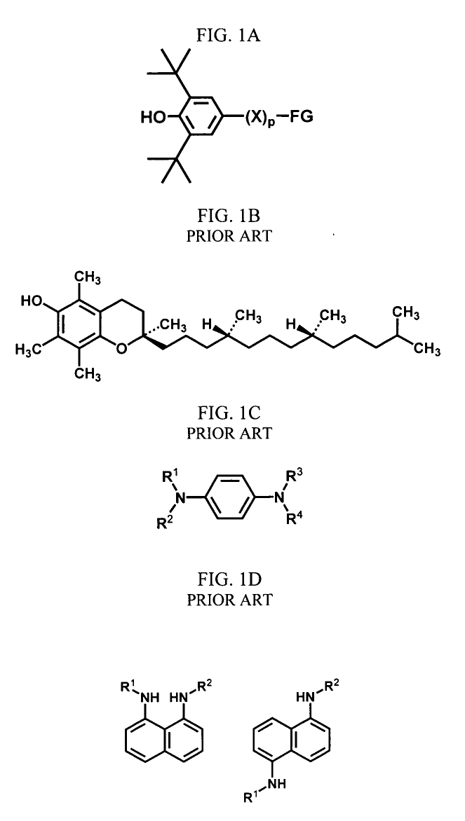

Modified antioxidants are then used to prepare degradation resistant polyurethanes of the invention. Non-limiting examples of antioxidants are phenolic antioxidants, compounds derived from 2,6-di-tert-butylphenol (e.g., 4-hydroxy-3,5-di-tert-butyltoluene, HBT) that are modified to contain reactive groups as shown in FIG. 1A.

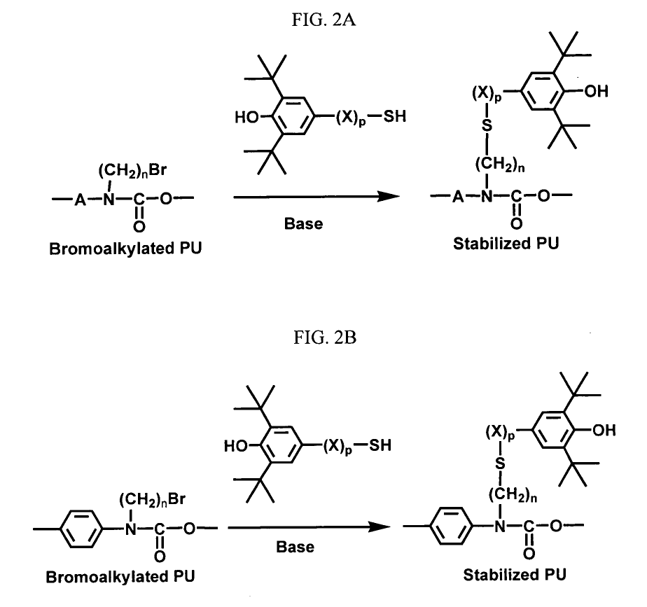

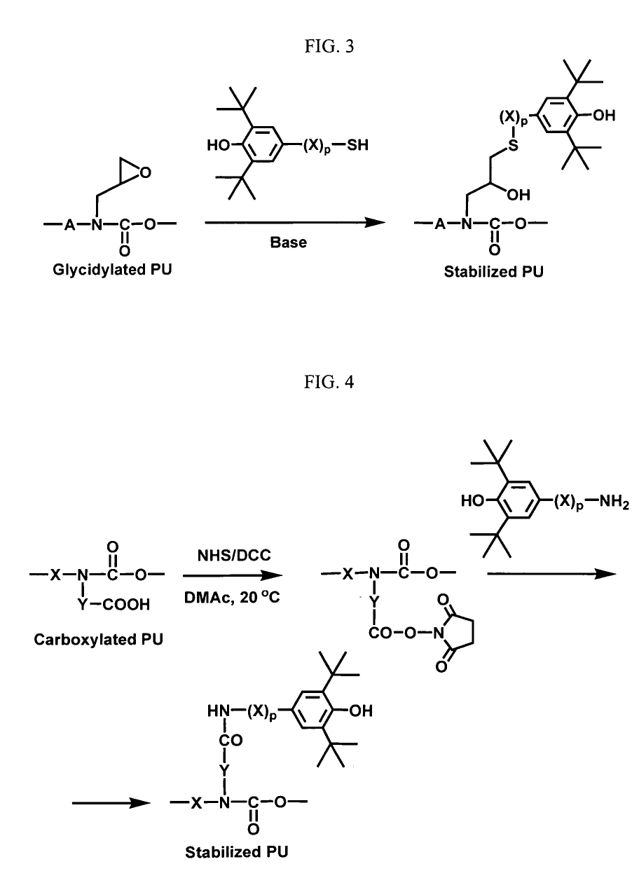

In one variant, the phenolic antioxidant can be provided with a thiol group (see FIGS. 2A, 2B, 3 and 12A). In another variant, the phenolic antioxidant can be provided with an amino group (see FIG. 4). Such thiol-activated or amino-activated antioxidants can further react with polyurethane derivatized, for example, with thiol- or amino-reactive functional groups (e.g., bromoalkyl, carboxy or epoxy groups), resulting in covalent attachment of the antioxidant to the polymer macromolecule, as shown in FIGS. 2A, 2B, 3, 4, 5A, 5B and 12A.

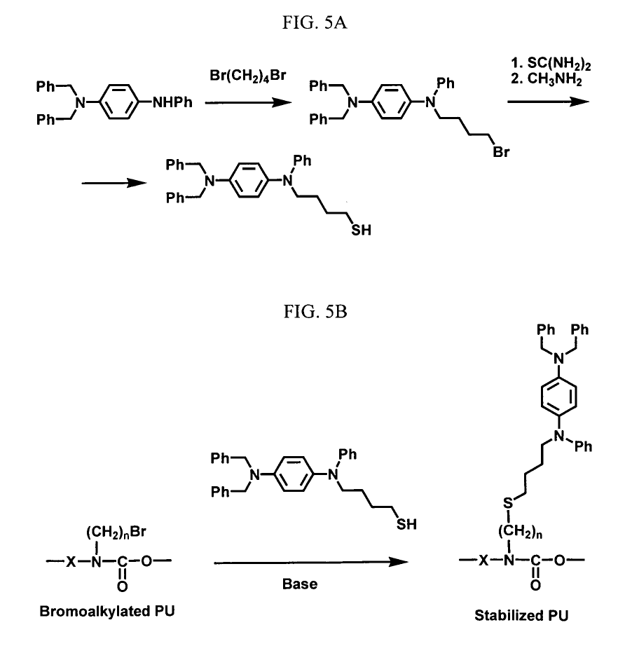

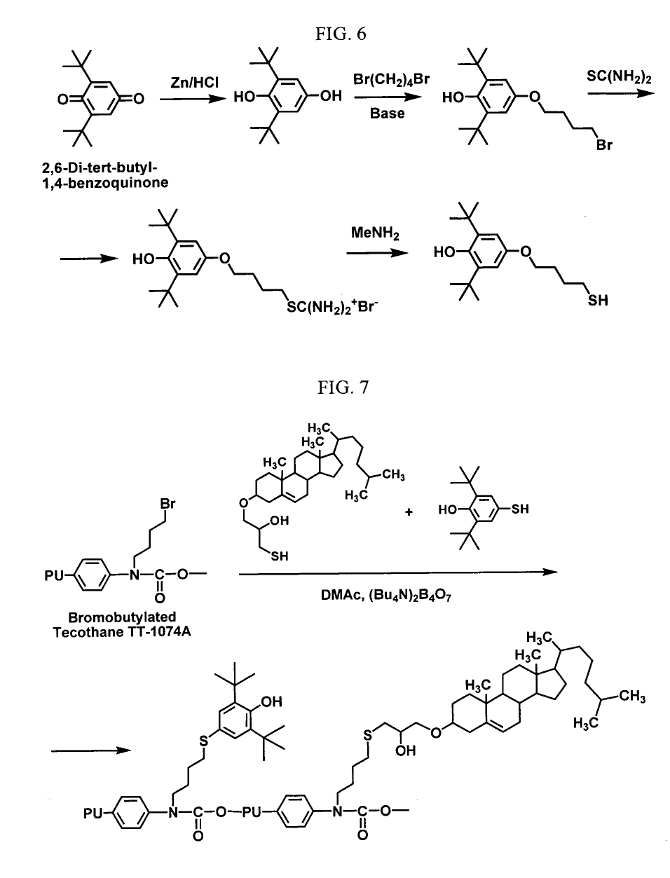

Other examples of antioxidants useful in this invention are those disclosed in U.S. Pat. No. 5,213,699 to Babiarz et al. (see FIG. 1C) and U.S. Pat. No. 5,198,134 to Steinberg et al. (see FIG. 1D) and relate to N-allyl and/or N-benzyl derivatives of p-phenylenediamine and N-alkenylated or N-methylene-thio substituted naphtalenediamines respectively. These antioxidants would have to be modified to contain reactive groups suitable for reacting with functional groups of derivatized polyurethanes. Non-limiting examples of such modification are shown on FIGS. 5A and 6.

Other methods of covalently binding an antioxidant to a polyurethane by use of a linker moiety that is different than the dihaloalkanes described above would be readily apparent to a skilled artisan. For example, polyurethane may be modified with pendant carboxy groups via N-hydroxysuccinimide esterification and subsequently reacted with an aminated antioxidant. More specifically, polyurethanes can be provided with pendant carboxy groups (as described in U.S. Pat. No. 6,320,011) either by direct carboxyalkylation (see, e.g., Example 2 of U.S. Pat. No. 6,320,011) or by carboxyl derivatization of pendant omega-bromoalkyl groups (see, e.g., Example 10 of U.S. Pat. No. 6,320,011). The carboxy groups can then be activated via N-hydroxysuccinimide esterification (U.S. Pat. No. 6,320,011) and reacted with an aminated antioxidant such as amino-derivatized 2,6-di-tert-butylphenol. The reaction scheme is exemplified in FIG. 4.

Further, the polyurethane of the invention can be prepared by using chain extenders comprising a leaving group (LG) suitable for nucleophilic substitution instead of multilinker as described above.

Chain extenders contemplated in the invention are of a kind known in the art. The chain extenders comprising an alkyl chain, at least one hydroxy group, and a leaving group as defined above are preferred.

In the method, polyurethane precursors terminated with isocyanate groups are used. In certain embodiments, polyurethane precursors are based on methylene diphenyl diisocyanate (MDI) or HMDI.

Next, the pendant functional groups are used for further reaction with reactive groups of antioxidants and additional reactants comprising functional moieties (e.g., steroid lipids and anti-calcification agents) to confer additional desired properties such as, for example resistance to calcification.

As skilled in the art can appreciate, the modification with antioxidants and other reactants can be performed on already formed polyurethane or on a prepolymer, an intermediate polymer, which is then converted into final high molecular weight polymer by further reaction with chain extenders.

The degradation resistant polyurethanes of the invention can have different antioxidants attached to the polyurethane backbone.

Modification of polyurethane with antioxidants to yield the degradation resistant polyurethane of the invention can be combined with attachment of other moieties useful for conferring additional desired characteristics such as for example, resistance to calcification, promoting or inhibiting cell adhesion and tissue proliferation, promoting attachment of biologically active species such as anticoagulants and anti-inflammatory substances. Non-limiting examples of such species are bisphosphonates and cholesterol. An example of simultaneous attachment of cholesterol and 4-mercapto-2,6-di-tert-butylphenol to TECOTHANE TT1074A modified with pendant 4-bromobutyl groups is shown in FIG. 7. Modification of polyurethane with steroid lipid is described in details in a PCT application Serial No. PCT/US04/021831 entitled “STEROID LIPID-MODIFIED POLYURETHANE AS AN IMPLANTABLE BIOMATERIAL, THE PREPARATION AND USES THEREOF,” by inventors, filed on Jul. 8, 2004 and U.S. application Ser. No. 10/521,994 filed on Jan. 19, 2005 which is a national phase of the above PCT application, which are incorporated herein in their entireties.

These moieties can be attached the simultaneously with, prior or after the attachment of the antioxidant. Preferably, the attachment of moieties is simultaneous with the attachment of the antioxidant.

Further, the invention provides a method of preventing or inhibiting oxidative degradation. The method comprises providing the degradation resistant polyurethane in a shape of an article, contacting the article with oxygen or oxygen-free radicals and thereby preventing or inhibiting oxidative degradation of the article.

The invention will be illustrated in more detail with reference to the following Examples, but it should be understood that the present invention is not deemed to be limited thereto.

### EXAMPLES

### Example 1

### Attachment of 4-Mercapto-2,6-Di-Tert-Butylphenol to Tecothane

Medical grade polyether-urethane TECOTHANE TT1074A was obtained as pellets from Thermedics Inc. (Woburn, Mass.) Bromobutylated TECOTHANE TT1074A was obtained as described in above mentioned U.S. patent application Ser. No. 10/672,893 and I. S. Alferiev and I. Fishbein: Activated polyurethane modified with latent thiol groups. Biomaterials (2002), 23, 4753-4758. According to ¹H NMR, 21% of the polymer's urethane segments were modified with pendant 4-bromobutyl groups, corresponding to ca. 0.45 mmol of 4-bromobutyl groups per 1 g of polymer. This polymer (2.063 g, containing ca. 0.97 mmol of 4-bromobutyl residues) was dissolved in N,N-dimethylacetamide (DMAc; 37 ml) under a flow of argon. The mixture was cooled to −2° C.

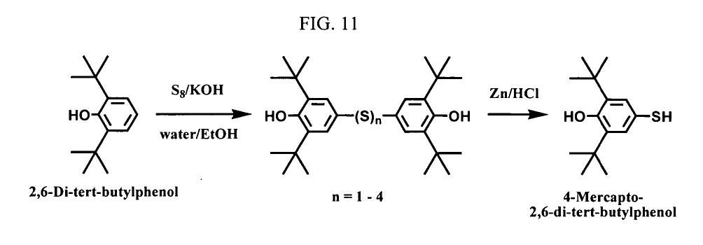

4-mercapto-2,6-di-tert-butylphenol was prepared using a modified procedure of T. Fujisawa, K. Hata and T. Kojima, Synthesis, 1973(1), 38-39) (see FIG. 11). A mixture of 2,6-di-tert-butylphenol (Aldrich, 8.20 g, 40 mmol), 85% KOH (4.00 g, 60.6 mmol), sublimed sulfur (6.70 g, 210 mmol) and absolute ethanol (30 ml) was stirred and refluxed for 40 min. The reaction solution was diluted with water (200 ml), neutralized to pH=9 with CO₂ and extracted with hexane (2×200 ml). The hexane phase was filtered and dried in vacuum, the residue was dissolved in PhMe (160 ml) and stirred with a mixture of water (120 ml) and ethanol (40 ml), whereas 12.1M HCl (240 ml) and Zn dust (40 g) were added in several portions over a period of 20 h. Finally, the mixture was diluted with water (110 ml), the organic layer was separated, filtered, washed with water and dried in vacuo. The residue (10.21 g) was purified by vacuum-distillation at 4 mm Hg, to afford 5.07 g (53%) of pure crystalline 4-mercapto-2,6-di-tert-butylphenol (Bp.=143-145° C.). Higher fractions contained di-(2,6-di-tert-butylphenyl) sulfide. ¹H NMR of 4-mercapto-2,6-di-tert-butylphenol (400 MHz, CDCl₃), δ, ppm: 1.41 (s, 18H, t-Bu), 3.34 (s, 1H, SH), 5.14 (s, 1H, OH), 7.16 (s, 2H, Ar—H).

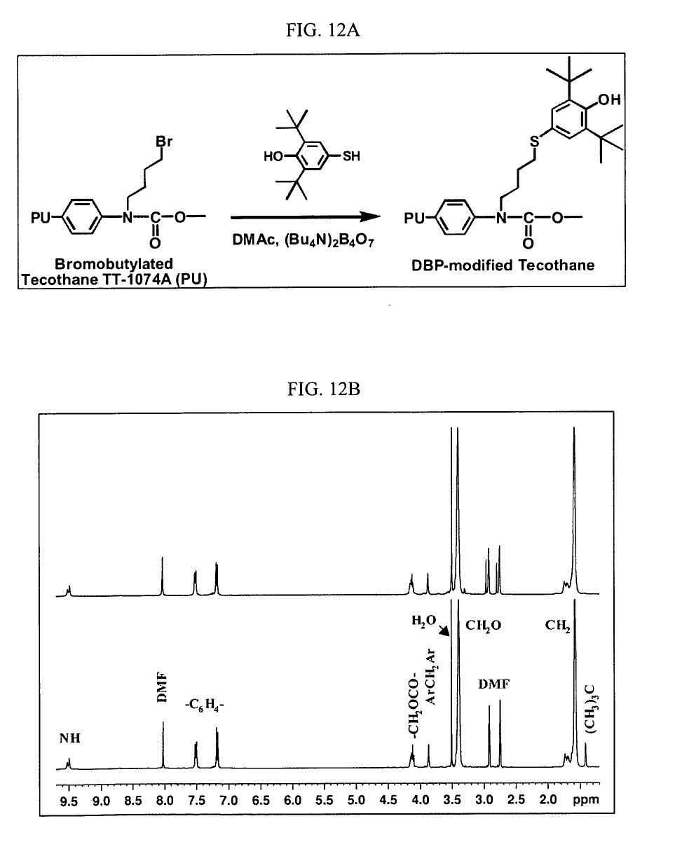

A solution of 4-mercapto-2,6-di-tert-butylphenol (0.476 g, 1.90 mmol) in DMAc (12 ml) was added, the mixture was further cooled to −5° C., and a freshly prepared 0.065 M DMAc-solution of (Bu₄N)₂B₄O₇ (15.4 ml, 1.0 mmol) was added. The mixture was stirred at −1 to 1° C. for 1 h and acidified with acetic acid (1.6 ml, 28 mmol). The reaction solution was filtered, the polymer was precipitated with cold (−5° C.) methanol, thoroughly washed with methanol, 2-propanol and water and dried under 0.05 mm Hg to the constant weight. The yield was 2.02 g. ¹H NMR-analysis indicated 21% of the segments bore residues of 2,6-di-tert-butyl phenol (DBP) as shown in FIG. 12A.

A schematic diagram of covalently attaching di-tert-butylphenol moieties to bromoalkylated urethane hard segments of poly(ether urethane) (TECOTHANE TT-1074A) is shown in FIG. 12A. Formation of modified polyurethane is confirmed by ¹H NMR spectra (in DMF-d₇) of bromobutylated TECOTHANE TT-1074A (top) and DBP-modified TECOTHANE (bottom) as shown in FIG. 12B. The signal of tert-butyl protons in the DBP-modified polymer is clearly noticeable at δ=1.42 ppm. Aromatic protons of DBP (at δ≈7.2 ppm) overlap with these of the PU hard segments, whereas the signal of OH can be noticed (with a higher amplification) at δ=7.08 ppm. The most intense signals belong to CH₂O and CH₂ of the polytetramethyleneoxide (PTMO) soft segments.

### Example 2

Bromobutylated TECOTHANE TT 1074A having a lesser degree of modification than that described in Example 1, was obtained as described above using a correspondingly diminished amount of lithium tert-butoxide. According to ¹H NMR, 6% of the polymer's urethane segments were modified with pendant 4-bromobutyl groups, corresponding to ca. 0.13 mmol of 4-bromobutyl groups per 1 g of polymer. This polymer (4.039 g, containing ca. 0.53 mmol of 4-bromobutyl residues) was dissolved in N,N-dimethylacetamide (DMAc; 90 ml) under a flow of argon and reacted with a solution of 4-mercapto-2,6-di-tert-butylphenol (0.289 g, 1.15 mmol) in DMAc (10 ml) and 0.055 M DMAc-solution of (Bu₄N)₂B₄O₇ (11.1 ml, 0.61 mmol) as described above. The polymer was precipitated, washed and dried analogously. The yield was 3.783 g. ¹H NMR-analysis indicated 6% of the segments bore residues of DBP.

### Example 3

### Cholesterol- and Antioxidant-Modified Tecothane TT1074A

A scheme of simultaneous attachment of cholesterol and 4-mercapto-2,6-di-tert-butylphenol to TECOTHANE TT1074A modified with pendant 4-bromobutul groups is shown in FIG. 7. Bromobutylated TECOTHANE was obtained as described in Example 1. This polymer (1.927 g, containing ca. 0.9 mmol of 4-bromobutyl residues) was dissolved in N,N-dimethylacetamide (DMAc; 35 ml) under a flow of argon. The mixture was cooled to −2° C.

A solution of 2-hydroxy-3-β-cholesteryloxypropanethiol (0.829 g, 1.74 mmol) (prepared as described in the above mentioned PCT application Serial No. PCT/US04/021831) and 4-mercapto-2,6-di-tert-butylphenol (30 mg, 0.12 mmol) in DMAc (15 ml) was added, the mixture was further cooled to −5° C., and a freshly prepared 0.13 M DMAc-solution of (Bu₄N)₂B₄O₇ (8.3 ml, 1.08 mmol) was added. The mixture was stirred at −1 to 1° C. for 1.5 h and acidified with acetic acid (0.25 ml, 4.37 mmol). The reaction solution was filtered, the polymer was precipitated with cold (−5° C.) methanol, thoroughly washed with methanol, 2-propanol and water and dried under 0.05 mm Hg to the constant weight. The yield was 2.184 g. ¹H NMR-analysis indicated that 18% of the polymer's urethane segments were modified with pendant cholesterol moieties, whereas 3% of the segments bore residues of 2,6-di-tert-butyl phenol (DBP) as shown in FIG. 7.

### Example 4

An established in vitro model of oxidative degradation (i.e., CoCl₂/H₂O₂ incubations) (see Schubert et al., J Biomed Mater Res (1997), Wiggins et al., J Biomed Mater Res A. (2003) September 1; 66(3):463-75, Tang et al., J Biomed Mater Res. (2001) December 15; 57(4):597-611, and Tanzi et al., J Biomed Mater Res. 1997 Sep. 15; 36(4):550-9) was used to demonstrate antioxidant modified polyurethane's resistance to in vivo oxidative degradation. Unmodified TECOTHANE films (1×3 cm) and TECOTHANE films modified with cholesterol, DBP, or a combination of cholesterol/DBP were immersed in an oxidative solution of 20% H₂O₂/0.1 M CoCl₂ for 15 days. Control films from the same preparation were placed in sterile dH₂O. Both solutions were changed every third day. At the completion of the experiment polyurethane films were removed from the oxidative and control solutions, washed extensively with dH₂O and vacuum dried. The extent of degradation was assessed by attenuated total reflectance Fourier transformation infrared spectroscopy (FTIR) and scanning electron microscopy (SEM). Relevant end points were used to show the effect of the oxidative environment on the tested polyurethane configuration's surface (SEM and contact angle) and bulk composition (FTIR and DMA).

The appearance of a peak in the ATR-FTIR spectra at 1170 is attributed to cross linking of ethers (Christenson 2004) as a result of oxidative degradation. The FTIR data from a peroxide-cobalt oxidation study are further summarized as shown in FIG. 8. FIG. 8 shows the relative 1170 cm⁻¹ peak intensity, normalized to the presence of aromatic rings (1599 cm⁻¹) which remain unchanged during oxidative degradation. FIG. 8 shows the normalized 1170 peak intensities for unmodified TECOTHANE, DBP and cholesterol modified polyurethanes as well as the cholesterol/DBP modified polyurethane. The covalent addition of either cholesterol (II) or DBP (III) reduced the 1170 cm⁻¹ peak intensity almost 5-fold compared to the unmodified TECOTHANE. Similarly the combination of cholesterol/DBP further reduced (˜8-fold reduction) ether cross linking compared to unmodified TECOTHANE.

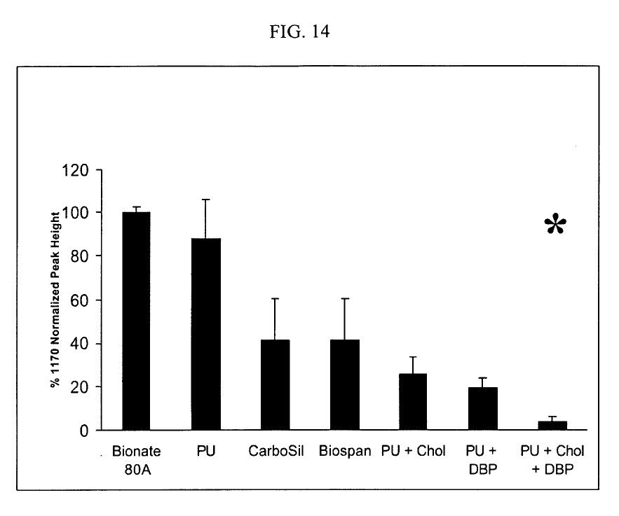

Recently, cross linked ether peaks (1170 cm⁻¹) were noted in poly(carbonate urethane) oxidative degradation products^{2,4}. Thus, the cross linked ether peak was used as a marker to compare oxidative degradation resistance between commercially available poly(carbonate urethane) and our covalently modified PU. Polycarbonate urethanes (CARBOSIL and BIONATE 80A) and the poly(ether urethane), BIOSPAN and PU (±covalent configurations), were oxidized via the CoCl₂/H₂O₂ protocol and assessed for the presence of cross linked ether. FIG. 14 is a quantitative assessment of 1170 cm−1 spectral peak heights, relative to the height of 1590 cm⁻¹ peak reflecting relative oxidative changes. The poly(carbonate urethane), BIONATE, and PU, a poly(ether urethane), had the most intense 1170 cm⁻¹ peaks relative to the 1590 cm⁻¹ reference peak. The additional poly (carbonate urethane) samples tested (BIONATE 80A, CARBOSIL, a polyurethane-silicone copolymer and BIOSPAN) had similar normalized 1170 cm⁻¹ peak heights. PU configured with either cholesterol or the anti-oxidant, DBP, were not significantly (p=0.6) different from each other with respect to the 1170 cm⁻¹ peak height. The 1170 cm⁻¹ spectral band of the dual configured PU+DBP+Chol was ten-fold less than the normalized band height for CARBOSIL (p=0.03). Of interest was a five-fold decrease in the 1170 cm⁻¹ peak height when both cholesterol and DBP were covalently appended to PU compared to the singular (cholesterol or DBP) molecular modification. DBP+Chol derivatized PU demonstrated superior resistance to oxidation-induced ether cross-linking than either cholesterol (p=0.05) or DBP (p=0.02) alone. PU-Chol/DBP demonstrated the lowest levels of either crosslinking per this endpoint. Ether cross-linking=Al₁₁₇₀/A₁₅₉₀×100%. * p<0.05 versus unmodified TECOTHANE.

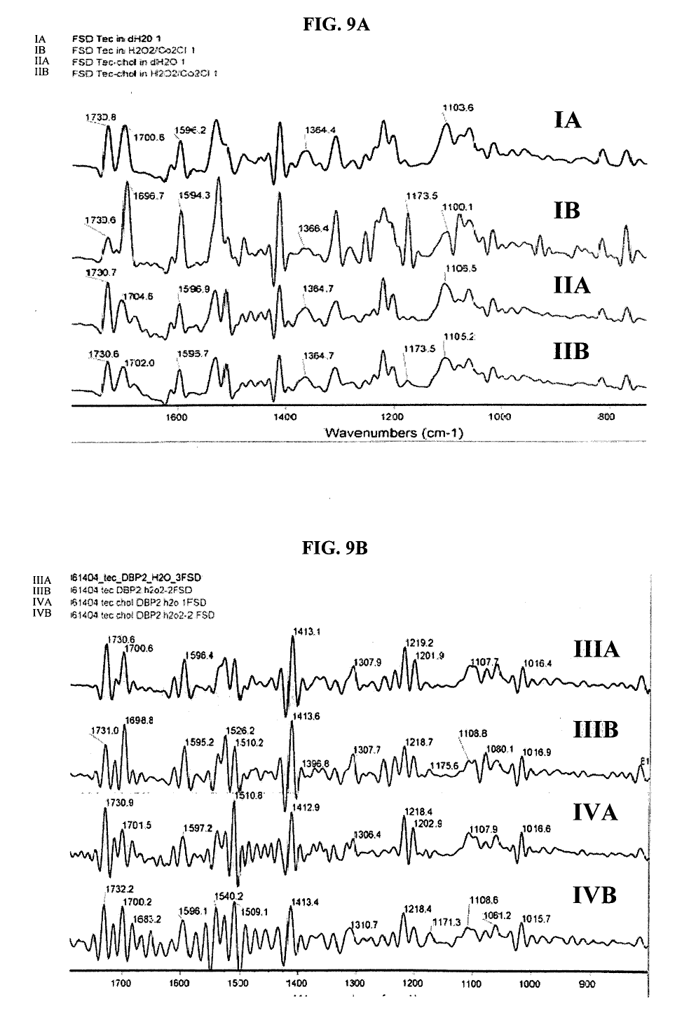

The representative ATR-FTIR spectra (FIGS. 9A and B) of the unmodified TECOTHANE, singularly modified (DBP or cholesterol) TECOTHANE, and DBP/Cholesterol modified TECOTHANE under control and oxidizing conditions. Alteration of peak intensities at 1730 cm⁻¹ and 1700 cm⁻¹ (urethane), 1100 cm⁻¹ (ether), and 1170 (cross linked ether) are grossly apparent in the unmodified TECOTHANE. In contrast the singularly modified (DBP or cholesterol) TECOTHANE, and DBP/Cholesterol modified configurations show less obvious changes. Of particular note is the greatly reduced intensity of the 1170 cm⁻¹ peak. These results show that modified TECOTHANE particularly the dual modified configuration are superior to unmodified TECOTHANE in preventing alteration to urethane moieties (1730 cm⁻¹ and 1700 cm⁻¹) and ether cross linking (1170 cm⁻¹).

Scanning electron microscopy (SEM) analysis shows extensive cavitations in the unmodified TECOTHANE exposed to an oxidative environment for 15 days. In contrast, surface morphology of the DBP modified polyurethane (PU+DBP) and the DBP/Cholesterol modified polyurethane was virtually identical between control and oxidized samples. These data further show that DBP modification confers anti-oxidant properties to polyether polyurethanes.

TABLE I
Dynamic Mechanical Analysis Results, Cholesterol Modified
TECOTHANE versus Unmodified TECOTHANE with and without
Peroxide-Co Oxidative Exposure

| PU Configuration | Tg (H₂O) | Tg (H₂O₂) |
|---|---|---|
| TECOTHANE | −40° C. | −29.78° C. |
| TECOTHANE + Cholesterol | −6° C. | −8° C. |
| TECOTHANE + Cholesterol + DBP | −6.5° C. | −18° C. |

Glass transition temperature (Tg) of polyurethane configurations exposed to water or oxidative degradation (H₂O₂ and COCl₂) was measured after 14 days at room temperature.

TABLE II
Contact Angle Results, Cholesterol Modified TECOTHANE versus
Unmodified TECOTHANE with and without Peroxide-Co
Oxidative Exposure

| PU Configuration | H₂O | H₂O₂ |
|---|---|---|
| TECOTHANE | 80.61 ± 3.5 | 68.7 ± 0.03 |
| TECOTHANE + Cholesterol | 98.47 ± 2.37 | 72.97 ± 6.65 |
| TECOTHANE + DBP | 81.29 ± 1.79 | 68.92 ± 6.89 |
| TECOTHANE + Cholesterol + DBP | 91.8 ± 3.35 | 79.67 ± 4.39 |

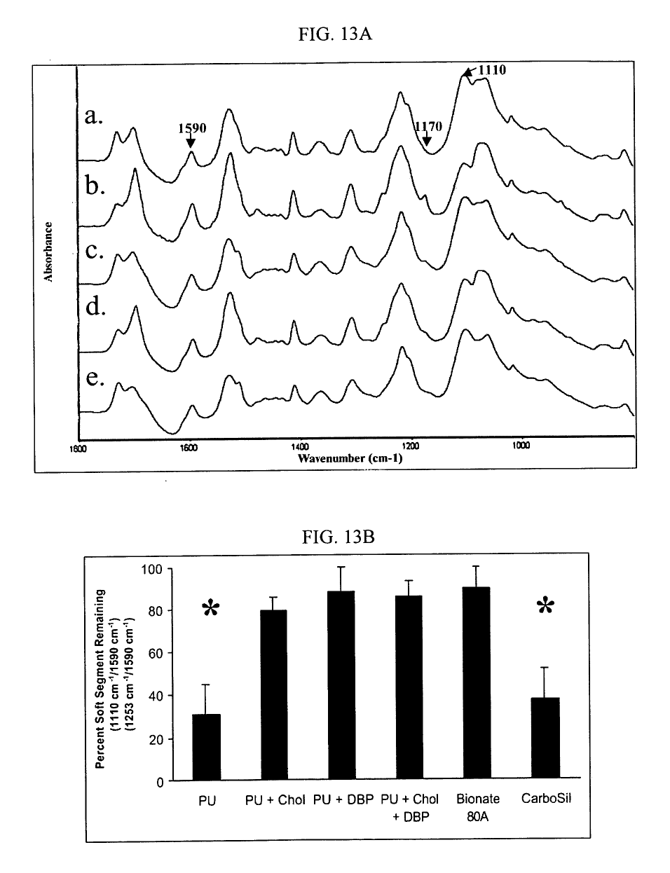

FIG. 13A shows characteristic ATR-FTIR spectra for solvent cast PU (poly(ether urethane) (TECOTHANE)) exposed for 15 days to a control solution of distilled water (FIG. 13A (sample a)) or a CoCl₂/H₂O₂ oxidative solution (FIG. 13A (sample b). In addition spectra from PU samples modified with cholesterol (PU+Chol) (FIG. 13A (sample c)), DBP (PU+DBP) (FIG. 13A (sample d)), or PU+DBP additionally configured with cholesterol (PU+DBP+Chol) (FIG. 13A (sample e)) that were exposed to oxidation conditions are also presented. Fifteen days exposure to a CoCl₂/H₂O₂ solution resulted in a decrease in the intensity of the 1110 cm⁻¹ peak in the unmodified PU, which is assigned to soft segment ethers as compared to non-oxidized control films. Additional FTIR spectral analyses (FIG. 13A) of the modified PU configurations exposed to oxidative conditions showed 1110 cm⁻¹ peak heights comparable to PU not exposed to oxidizing conditions. Quantification of soft segment retention (FIG. 13B) shows significant (p=0.02) loss of soft segment ethers in oxidized PU compared to modified PU configurations. Modified configurations retained 80%-85% of soft segment ether, and there was no significant difference between the singularly modified or the combined DBP cholesterol configured TECOTHANE. Soft segment loss, as determined from 1253 cm⁻¹ peak intensities, was also examined in selected unmodified polycarbonate polyurethanes exposed to oxidative conditions for 15 days (FIG. 13B). BIONATE 80A showed resistance to oxidative degradation as indicated by the high levels (˜90%) of retained soft segment. In contrast, CARBOSIL 90A showed extensive soft segment loss with only an estimated 38% soft segment remaining per FTIR after 15 days exposure to the oxidative solution.

FTIR spectral analysis of oxidized unmodified PU (FIG. 13A (sample b) shows the appearance of an oxidative degradation product at the 1170 cm⁻¹ peak, which is indicative of cross-linked ethers. The large reduction in the 1170 cm⁻¹ peak intensity from the spectra of oxidized PU+Chol, PU+DBP films indicated resistance to oxidative degradation as a result of chemical modification. In addition, the combinatorial modification PU+DBP+Chol appears to have a cumulative greater resistance to oxidative degradation than the individual modifications.

### Example 5

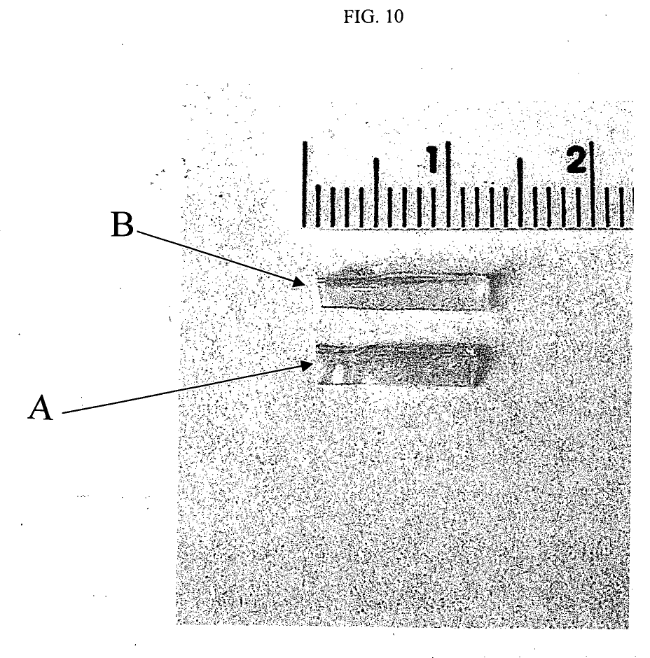

Both the unmodified polyurethane and DBP-and cholesterol-modified polyurethanes (as described in Example 2) were cast into films from THF-solutions, the films were stored in air at ambient temperature for 9 months. The film made from unmodified polyurethane turned yellowish, and its mechanical strength was grossly decreased, whereas the DBP- and cholesterol-protected film remained without any noticeable changes (see FIG. 10). Unfortunately, crosslinking precluded exact determination of the molecular weight loss in the non-protected sample.

### Example 6

### Cholesterol- and Antioxidant-Modified Polyurethane-Urea Biospan

Polyurethane-urea BIOSPAN was obtained from the Polymer Technology Group Medical LLC (Berkeley, Calif.) as a 24% solution in DMAc. The polymer was precipitated from the solution and characterized as described previously (see I. S. Alferiev, N. R. Vyavahare, C. X. Song and R. J. Levy: Elastomeric polyurethanes modified with geminal bisphosphonate groups. Journal of Polymer Science: Part A: Polymer Chemistry 2001, 39, 105-116). Content of urethane groups was 0.91 mmol/g.

Bromobutylated BIOSPAN. The precipitated polymer (15.7 g, containing ca. 14 mmol of urethane groups) was dried by soaking in toluene followed by solvent removal at 40-60° C. (0.1 mm Hg) and dissolved in anhydrous DMAc (330 ml) under dry argon. Distilled 1,4-dibromobutane (15 ml, 126 mmol) was added, the mixture was cooled to −5° C., and a 1M solution of lithium tert-butoxide in hexanes (Sigma-Aldrich, 7.5 ml, 7.5 mmol) diluted with dry DMAc (28 ml) was added over a 10-min period with vigorous stirring at −5 to −8° C. The mixture was stirred at −1 to 1° C. for 1 h and acidified with acetic acid (2.0 ml, 35 mmol). The reaction solution was filtered, and the polymer was precipitated by pouring the mixture into a large volume (1200 ml) of cold (−60° C.) methanol. After warming to 0° C., the coagulate of polymer was filtered off, thoroughly washed with methanol, 2-propanol and water, then vacuum-dried at room temperature and 0.03-0.05 mm Hg. The yield was 15.01 g. ¹H-NMR analysis found 51% of urethane segments modified with 4-bromobutyl groups, corresponding to ca. 0.45 mmol/g.

Cholesterol- and antioxidant-modified BIOSPAN (PU+Chol+DBP). The bromobutylated polymer (7.576 g, containing ca. 3.4 mmol of 4-bromobutyl groups) was dissolved in anhydrous DMAc (138 ml) under dry argon and cooled to −5° C. A solution of 2-hydroxy-3-β-cholesteryloxypropanethiol (3.200 g, 6.71 mmol) (prepared as described in the PCT application Serial No. PCT/US04/021831) and 4-mercapto-2,6-di-tert-butylphenol (0.118 g, 0.47 mmol) in DMAc (60 ml) was added, the mixture was further cooled to −10° C., and a freshly prepared 0.16 M DMAc-solution of (Bu₄N)₂B₄O₇ (26.2 ml, 4.2 mmol) was added. The mixture was stirred at −1 to 1° C. for 1.5 h and acidified with acetic acid (0.90 ml, 15.8 mmol). The reaction solution was filtered, the polymer was precipitated with cold (−65° C.) methanol. After warming to room temperature, the coagulate of polymer was filtered off, thoroughly washed with methanol, 2-propanol and water and dried under 0.05 mm Hg to the constant weight. The yield was 8.431 g. ¹H NMR-analysis indicated that 44% of the polymer's urethane segments were modified with pendant cholesterol moieties, whereas 7% of the segments bore residues of 2,6-di-tert-butyl phenol (DBP).

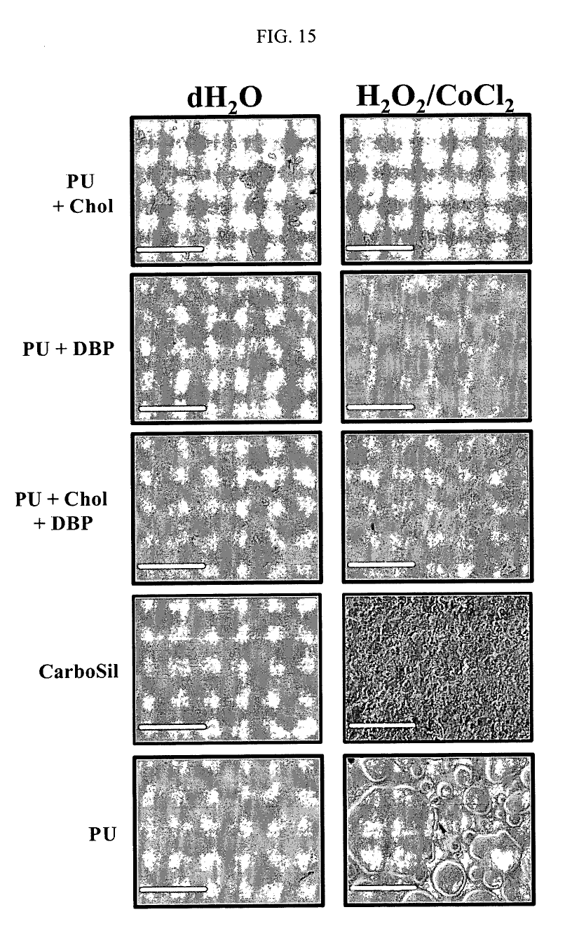

Scanning electron microscopy (SEM) was used to visually assess the effects of oxidation-induced surface degradation upon poly (carbonate urethanes) and PU±covalent modification). FIG. 15 contains scanning electron micrographs of polyurethane configurations showing changes in surface morphology as a result of oxidative degradation. TECOTHANE (PU), PU+Chol, PU+DBP, PU+Chol/DBP, and CARBOSIL were exposed to CoCl₂/20% H₂O₂ for 15 days at 37° C. Representative micrographs show profound surface changes in oxidized CARBOSIL and unmodified PU samples with no detectable change in DBP and Chol modified PU. Bar equals 250 μm. FIG. 15 shows extensive changes in the surface of CARBOSIL and unmodified-PU. CARBOSIL, a poly (carbonate urethane) silicone copolymer, had a roughened surface after fifteen-days exposure to H₂O₂-Co/Cl₂ treatment. PU, a poly (ether urethane), had significant cavitation and fenestration throughout the film following oxidative exposure. In contrast covalently appending DBP, Chol, or a combination of the two to PU significantly prevented oxidative surface degradation per SEM results.

Changes in the surface free energy, as quantified by contact angle measurements, were used to assess oxidation-mediated effects on the modified polyurethane surfaces. As shown in Table II, all polyurethane configurations had a reduction in surface energy as a result of oxidation. The greatest differences in contact angle were seen in the PU+Chol samples. This loss of surface energy strongly suggests that the cholesterol modification was damaged as a result of oxidation.

These results are the first demonstration of preventing oxidative degradation of polyurethane surfaces by covalent attachment of an anti-oxidant to a poly (ether urethane) using bromoalkylation synthetic chemistry⁶. In addition, we characterized the effect of oxidative degradation on a number of commercially available medical grade polyurethanes and compared these results with modified polyurethane formulations. Covalently appended DBP or Chol significantly inhibited oxidative degradation as evident by the reduction of the 1170 cm⁻¹ peak and the retention of ether compared to unmodified control TECOTHANE. Interestingly, FTIR analysis showed that TECOTHANE configured with both DBP and Chol showed significantly greater resistance to oxidation initiated ether cross linking, compared to singularly modified TECOTHANE, as evidence by a virtual absence of an 1170⁻¹ cm peak.

Polyurethanes are widely used clinically in cardiovascular implants^{17,18}. However, polyether soft segments are susceptible to oxidative cleavage attributed to reactive oxidative species secreted from adherent macrophages¹⁹. CoCl₂₁H₂O₂ incubations have been used as an accelerated model system to mimic in vitro this oxidative degradation^{1,2,11,15}. Using this model a comparison was made between vitamin E and SANTOWHITE®, a phenolic-antioxidant, showing that 11.6 mmol/kg vitamin E codissolved into a poly(ether urethane) solution for solvent casting films was superior to a dissolved SANTOWHITE e® in inhibiting oxidative degradation⁵. We present herein an alternate strategy in which the anti-oxidant, di-tert-butylphenol, is covalently linked to the polyurethane block copolymer via hard segment bromoalkylation⁶. In this present study, we showed profound inhibition of oxidative degradation with a concentration of 0.12 mmol/gram of DBP that is covalently attached to the polyurethane block copolymer backbone in bulk, thereby also ensuring a uniform distribution of antioxidant that is not susceptible to leaching. While there is no published data on leaching of antioxidant cocipients, nevertheless the anti-oxidant effect mediated by all the anti-oxidants used, including DBP and related phenols per the present study, results in the neutralization of these agents by superoxides. Thus, eventually the anti-oxidant load regardless of the inclusion mechanism will be depleted. Therefore, the higher loading achievable with covalent attachment versus blending would hypothetically provide longer lasting protection against oxidation.

Poly(carbonate urethanes) are considered to be relatively more stable to oxidative degradation than polyether polyurethanes. However, chain scission and ether crosslinking was noted by others in poly(carbonate urethanes), BIONATE 80A, in vivo and in vitro². Indeed these results showed a similar level of ether cross linking between BIONATE 80A and unmodified TECOTHANE as evident in the normalized 1170 cm⁻¹ band height (FIG. 2). In these experiments we used FTIR and SEM to compare further oxidative degradation resistance between poly (carbonate urethanes) and covalently modified poly(ether urethanes). Comparisons between these polyurethanes and modified TECOTHANE configurations showed that TECOTHANE modified with either cholesterol or DBP were significantly better than unmodified polyurethane in preventing ether cross linking as evident by the 4-fold reduction in the normalized 1170 cm⁻¹ band height. These singularly modified polyurethanes were also superior to CARBOSIL and BIOSPAN with respect to inhibition of ether cross-linking. Thus, in this study we show that a combinatorial modification of DBP and Chol appended to TECOTHANE optimally prevented ether cross linking. This polyurethane configuration was significantly better at preventing ether-crosslinking than any other tested polyurethane.

In the present results, a qualitative analysis of surface degradation, as determined by SEM, supported the FTIR results confirming the oxidation resistance of PU+DBP, PU+Chol, and PU+DBP+Chol compared to controls. In contrast, we found extensive cavitation on the surface of the unmodified poly(ether urethane). These positive results demonstrating oxidative damage with unmodified polyurethanes are consistent with previous work by others detailing severe surface degradation in vivo and in vitro of poly(ether urethanes)^{1,5,16}. Furthermore, this study showed surface alteration of oxidized poly(carbonate urethanes), that are viewed as relatively oxidation resistant. Exposure of CARBOSIL, a polycarbonate urethane containing copolymerized silicone, to an oxidation solution resulted in surface deformation throughout the film as evident by SEM. In contrast, there was little or no change in the surface appearance of the DBP or DBP/Chol covalently modified PU. These results strongly support the efficacy of covalently appending anti-oxidants or cholesterol via bromoalkylation of activated urethane segments as a viable strategy for addressing oxidative degradation of PU vascular implants.

It was shown previously by inventors that the addition of Chol to PU confers increased hydrophobicity to the polyether polyurethane⁹. We show herein that PU modified with only Chol was equally resistant to oxidative degradation as PU appended with DBP alone. This observation is of interest since cholesterol does not possess anti-oxidant properties and is subject to enzymatic oxidation in vivo²⁰. The profound decrease in contact angle (surface energy) of the PU-Chol films following oxidation, shown in Table I, suggests that the surface oriented cholesterol moieties are being damaged as a result of oxidative degradation, and thus likely serve as a temporary barrier against oxidative mediated degradation of the ether soft segments. This may hypothetically explain why the FTIR spectra show no damage to the PU soft segment. This hypothesis is also supported in view of the dual modification (DBP and Chol) results. The DBP and Chol modified PU showed an even greater resistance than either modification alone to oxidative degradation suggesting two synergistic independent mechanisms for inhibiting oxidative degradation.

In other studies not related to oxidation resistance, inventors used bromoalkylated synthetic chemistry for in vivo implants, constructing polyurethane heart valve leaflets configured with therapeutic moieties. Inventors showed previously that pulmonary heart valve leaflets composed of polyurethane with covalently appended bisphosphonate, an anti-calcification agent, resisted ectopic calcification in heart valve leaflet implants beyond five months in a juvenile sheep model^{7,8}. This same bisphosphonate containing polyurethane was further modified by covalently attaching cationic diethylamino groups to inhibit water absorption⁸. These previous results show the feasibility of constructing vascular devices with polyurethane that has been configured with multiple therapeutic molecules via bromoalkylation strategy, and thus establish the basis for investigating implants using the anti-oxidative chemistry described herein.

PU+Chol was shown in other studies by our group in vitro to enhance endothelial cell affinity for the PU+Chol under simulated arterial levels of shear⁹. The results presented herein support a strategy for constructing a polyurethane vascular implant composed of a dual configured Chol+DBP modified polyurethane, that hypothetically could both retain seeded endothelial cells to prevent thrombus formation and resist oxidative degradation.

The experiments described above demonstrate that polyurethanes configured with DBP and/or Chol are significantly resistant to oxidative degradation compared to both control (unmodified) polyurethane, and commercially available polyurethanes demonstrated to be relatively resistant to oxidative degradation. These findings support the view that DBP and/or Chol-modified PU represents a potential solution for the problem of oxidative degradation of polyurethanes in long term cardiovascular implants.

### Methods Used in Experiments Described in Examples

Degradation Studies

PU films (150 μm thick×1 cm×3 cm) composed of PU (TECOTHANE), PU+DBP, PU+Cholesterol, and PU+DBP+Cholesterol (PU+DBP+Chol) were individually immersed for 15 days in 20% H₂O₂+0.1 M CoCl₂ or a control solution of distilled water. Films were then incubated for 15 days at 37° C. Solutions were changed every third day. At the conclusion of the study, films were rinsed in dH₂O and vacuum dried at room temperature and stored in a dessicator at −20° C. until further analysis.

Contact Angle Analysis

The water contact angle on unmodified PU, PU+DBP, or PU+DBP+Chol films was measured on oxidized and control samples using a custom built imaging goniometer system using established methodology (see Stachelek et al., Cholesterol-derivatized polyurethane: Characterization and endothelial cell adhesion. J Biomed Mater Res 2005; 72A:200-212) and was recorded as the average of eight measurements of each sample. The sessile drops were immediately visualized using a CCD camera (Edmund Scientific Co., Barrington, N.J.) and contact angle measurements were analyzed using Scion Image analysis software package (Scion Inc., Frederick, Md.).

Fourier Transform Infrared Spectroscopy-Attenuated Total Reflectance

Fourier transform infrared spectra of the samples were measured by attenuated total reflectance spectroscopy (FTIR-ATR) using a Nicolet 5-Protege 460 spectrophotometer E.S.P. (Nicolet, Madison, Wis.). All spectra were obtained from 200 scans collected at a resolution of 2 cm⁻¹ at a 45° angle of incidence. All spectra were recorded under identical conditions and adjusted for atmospheric water vapor and carbon dioxide transmittance by subtraction of the appropriate reference spectrum using the OMNIC software package (Nicolet).

Scanning Electron Microscopy (SEM)

Surface morphology of the control and oxidized polyurethane configurations was analyzed using SEM. Samples were sputter coated with gold (thickness=1-2 nm) and examined with a JEOL 6300 FV SEM (Peabody, M A) at a 5 keV acceleration voltage.

Statistical Analysis

Data were calculated as means±standard error (SE). Statistical significance was noted with p≦0.05.

While the invention has been described in detail and with reference to specific examples thereof, it will be apparent to one skilled in the art that various changes and modifications can be made therein without departing from the spirit and scope thereof.

### REFERENCES

1. Schubert M A, Wiggins M J, Anderson J M, Hiltner A. Role of oxygen in biodegradation of poly(etherurethane urea) elastomers. J Biomed Mater Res 1997; 34:519-30.
2. Christenson E M, Anderson J M, Hiltner A. Oxidative mechanisms of poly(carbonate urethane) and poly(ether urethane) biodegradation: In vivo and in vitro correlations. J Biomed Mater Res 2004; 70A:245-55.
3. Stokes K, McVenes R, Anderson J M. Polyurethane elastomer biostability. J Biomater Appl 1995; 9:321-54.
4. Christenson E M, Dadsetan M, Wiggins M, Anderson J M, Hiltner A. Poly(carbonate urethane) and poly(ether urethane) biodegradation: in vivo studies. J Biomed Mater Res 2004; 69A:407-16.
5. Schubert M A, Wiggins M J, Anderson J M, Hiltner A. Comparison of two antioxidants for poly(etherurethane urea) in an accelerated in vitro biodegradation system. J Biomed Mater Res 1997; 34:493-505.
6. Alferiev I, Fishbein I. Activated polyurethane modified with latent thiol groups. Biomaterials 2002; 23:4753-4758.
7. Alferiev I, Vyavahare N, Song C, Levy R J. Elastomeric polyurethanes modified with geminal bisphosphonate groups. J Poly Sci 2001; 39:105-116.
8. Alferiev I, Stachelek S J, Lu Z, Fu A L, Sellaro T L, Connolly J M, Bianco R W, Sacks M S, Levy R J. Prevention of polyurethane valve cusp calcification with covalently attached bisphosphonate diethylamino moieties. J Biomed Mater Res 2003; 66A:385-95.
9. Stachelek S J, Alferiev I, Choi H, Kronsteiner A, Uttayarat P, Gooch K J, Composto R J, Chen I-W, Hebbel R P, Levy R J. Cholesterol-derivatized polyurethane: Characterization and endothelial cell adhesion. J Biomed Mater Res 2005; 72A:200-212.
10. Stachelek S J, Alferiev I, Connolly J M, Sacks M S, Hebbel R P, Bianco R W, R. J. L. Cholesterol-modified polyurethane valve cusps demonstrate blood outgrowth endothelial cell adhesion post-seeding in vitro and in vivo. Ann Thorac Surg 2005; in press.
11. Schubert M A, Wiggins M J, Schaefer M P, Hiltner A, Anderson J M. Oxidative biodegradation mechanisms of biaxially strained poly(etherurethane urea) elastomers. J Biomed Mater Res 1995; 29:337-47.
12. Zhao Q H, McNally A K, Rubin K R, Renier M, Wu Y, Rose-Caprara V, Anderson J M, Hiltner A, Urbanski P, Stokes K. Human plasma alpha 2-macroglobulin promotes in vitro oxidative stress cracking of Pellethane 2363-80A: in vivo and in vitro correlations. J Biomed Mater Res 1993; 27:379-88.
13. Zhao Q, Casas-Bejar J, Urbanski P, Stokes K. Glass wool-H₂O₂/CoCl₂ test system for in vitro evaluation of biodegradative stress cracking in polyurethane elastomers. J Biomed Mater Res 1995; 29:467-75.
14. Fujisawa T, Hata K, Kojima T. The sulfuration of sterically hindered phenols with sulfur. A convenient synthesis of 4,4,′-thio-bis-[2,6-dialkylphenols] and 2,6-dialkyl-4-mercaptophenols. Synthesis 1973; 1:38-39.
15. Wiggins M J, MacEwan M, Anderson J M, Hiltner A. Effect of soft-segment chemistry on polyurethane biostability during in vitro fatigue loading. J Biomed Mater Res 2004; 68A:668-83.
16. Fare S, Petrini P, Motta A, Cigada A, Tanzi M C. Synergistic effects of oxidative environments and mechanical stress on in vitro stability of polyetherurethanes and polycarbonateurethanes. J Biomed Mater Res 1999; 45:62-74.
17. Szycher M, Siciliano A A, A M R. Polyurethane elastomers in medicine. New York, N.Y.: CRC Press; 1994. 233-244.
18. Hasirici N. Polyurethanes. Lancaster, Pa.: Technomic Publishing Co.; 1991. 233-244.
19. Zhao O H, Anderson J M, Hiltner A, Lodoen G A, Payet C R. Theoretical analysis on cell size distribution and kinetics of foreign-body giant cell formation in vivo on polyurethane elastomers. J Biomed Mater Res 1992; 26:1019-38.
20. Smith L L. Cholesterol autoxidation 1981-1986. Chem Phys Lipids 1987; 44:87-125.
Tang et al., Enzyme-induced biodegradation of polycarbonate-polyurethanes: dependence on hard-segment chemistry, J Biomed Mater Res. (2001) December 15; 57(4):597-611.
Schubert et al., Comparison of two antioxidants for poly(ether urethane urea) in an accelerated in vitro biodegradation system, J Biomed Mater Res (1997); 34(4):493-505.
Wiggins et al., Effect of strain and strain rate on fatigue-accelerated biodegradation of polyurethane, J Biomed Mater Res A. (2003) Sep 1; 66(3):463-75.
Tanzi et al., Chemical stability of polyether urethanes versus polycarbonate urethanes, J Biomed Mater Res. 1997 Sep. 15; 36(4):550-9.

What is claimed is:

1. A degradation resistant polyurethane comprising a modified hard segment comprising a urethane nitrogen and an antioxidant substituent, wherein the antioxidant substituent is pendant from the urethane nitrogen.

2. The degradation resistant polyurethane of claim 1, wherein the antioxidant substituent is a member selected from the group consisting of a phenol derived substituent, a phenylendiamine derived substituent, a naphtalenediamine derived substituent, and a vitamine E derived substituent.

3. The degradation resistant polyurethane of claim 1, wherein the phenol derived substituent comprises a 2,6-di-tert-butylphenol derived substituent.

4. The degradation resistant polyurethane of claim 1, wherein the 2,6-di-tert-butylphenol derived substituent has a formula: 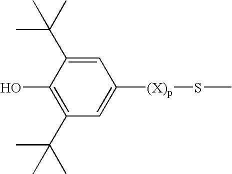
wherein p equals 1 or 0, and X is a C₁-C₂₀ alkylene or a C₁-C₂₀ arylene, wherein the C₁-C₂₀ alkylene and/or the C₁-C₂₀ arylene optionally comprise heteroatoms.

5. The degradation resistant polyurethane of claim 1, wherein the 2,6-di-tert-butylphenol derived substituent is a 4-hydroxy-3,5-di-tert-butyltoluene derived substituent.

6. The degradation resistant polyurethane of claim 1, wherein the modified hard segment comprises an aromatic or a cyclohexane group bound to the urethane nitrogen.

7. The degradation resistant polyurethane of claim 1, wherein the modified hard segment has the formula: 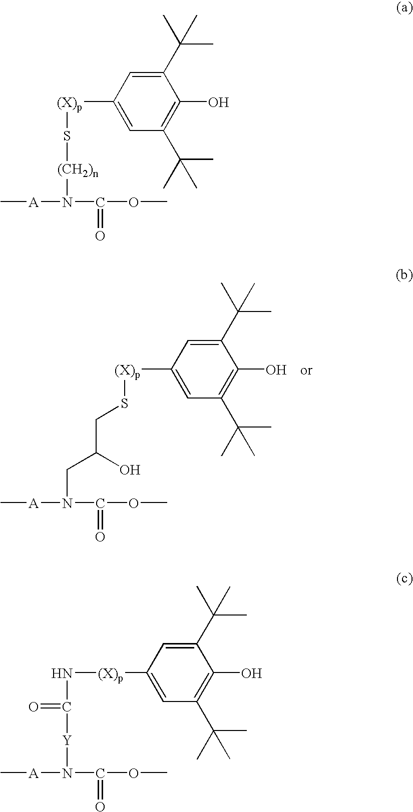
wherein A is an aromatic or a cycloaliphatic group, Y is an (n+1)-valent organic radical comprising at least one carbon atom.

8. The degradation resistant polyurethane of claim 7, wherein the modified hard segment has the formula:

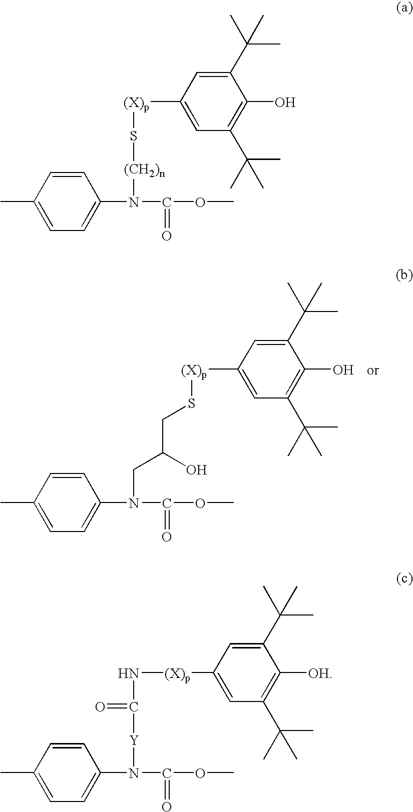

9. The degradation resistant polyurethane of claim 1, wherein the antioxidant substituent is pendant from about 0.5 to about 55% of urethane nitrogens.

10. The degradation resistant polyurethane of claim 1, wherein the degradation resistant polyurethane has at least two different antioxidant substituents pendant from the urethane nitrogens.

11. The degradation resistant polyurethane of claim 1, further comprising a functional moiety pendant from a different urethane nitrogen.

12. The degradation resistant polyurethane of claim 11, wherein the functional moiety is at least one of steroid lipid and bisphosphonate.

13. The degradation resistant polyurethane of claim 11, wherein the antioxidant substituent comprises the 2,6-di-tert-butylphenol derived substituent and the functional moiety comprises cholesterol.

14. The degradation resistant polyurethane of claim 1 in a shape of an article or in a shape of a coating on the article.

15. The degradation resistant polyurethane of claim 14, wherein the article is an implant.

16. A method of making the degradation resistant polyurethane of claim 1, the method comprising:
providing a polyurethane comprising a hard segment comprising a urethane amino moiety;
treating the polyurethane to form a derivatized polyurethane comprising a derivatized hard segment having a first reactive group pending from a urethane nitrogen, and wherein the derivatized hard segment has a formula:
-A-N(Y-(FG)ₙ)(C(═O)O—)
wherein n is an integer from 1 to 3, FG is the first reactive group which is selected from a halogen, a carboxyl group, a substituted carboxyl group, a sulfonate ester, and an epoxy group, and Y is an (n+1)-valent organic radical comprising at least one carbon atom;
providing a derivatized antioxidant comprising a second reactive group; and
reacting the first reactive group with the second reactive group to make the degradation resistant polyurethane.

17. The method of claim 16, wherein Y is a bivalent organic radical selected from the group consisting of C₁ to C₂₀ alkylene, C₁ to C₂₀ alkyleneamino, C₁ to C₂₀ alkyleneoxy, C₁ to C₂₀ haloalkylene, C₂ to C₂₀ alkenylene, C₆ to C₂₀ arylene, a modified C₂ to C₂₀ alkenylene having at least one carbon substituted by a halogen group, C₂ to C₂₀ alkenylene having one or more O, S, or N atoms incorporated into an alkenylene chain, a bivalent heterocyclic radical, and mixtures thereof.

18. The method of claim 16, wherein Y is a member selected from the group consisting of a C₁-C₆ alkylene and (CH₂)_{q}S(CH₂)ₘ wherein q is 1-6 and m is 1-2.

19. The method of claim 16, wherein treating the polyurethane is performed by reacting with a multifunctional linker reagent of a formula:
LG-Y-(FG)ₙ
wherein LG is a leaving group selected from the group consisting of a halogen, a carboxyl group, a sulfonate ester, and an epoxy group.

20. The method of claim 19, wherein the multifunctional linker reagent is a member selected from the group consisting of a dibromoalkyl compound, a bromo-carboxyalkyl compound, and a bromo-epoxyalkyl compound.

21. The method of claim 16, wherein the hard segment comprises an aromatic or a cycloaliphatic group bound to the urethane nitrogen.

22. The method of claim 16, wherein the second reactive group is at least one of an amino group and a thiol group.

23. The method of claim 16, wherein the hard segment comprises the aromatic group bound to the urethane nitrogen, the first reactive group is the carboxyl group, the second reactive group is the amino group and the derivatized polyurethane is reacted with N-hydroxysuccinimide.

24. The method of claim 16, further comprising providing an additional reactant comprising a functional moiety.

25. The method of claim 24, wherein the additional reactant is provided simultaneously with the derivatized antioxidant.

26. The method of claim 24, wherein the additional reactant is a member selected from the group consisting of steroid lipid and bisphosphonate.

27. A method of preventing or inhibiting oxidative degradation of an article, the method comprising:
providing the degradation resistant polyurethane of claim 1, said degradation resistant polyurethane is in a shape of the article or in a shape of a coating on the article; and
contacting the article or the coating with oxygen or oxygen-free radicals and thereby preventing or inhibiting oxidative degradation of the article.

28. The method of claim 27, wherein the article is contacted with a tissue.

29. The method of claim 28, wherein the article is an implantable device.
